(19) United States
(12) Patent Application Publication
(10) Pub. No.: US 2008/0094220 A1
(43) Pub. Date: Apr. 24, 2008

(54) Methods and Systems for Improving RFID Security

(76) Inventors: Joseph Foley, Cambridge, MA (US); Sanjay Sarma, Belmont, MA (US)

Correspondence Address: DANN, DORFMAN, HERRELL & SKILLMAN, 1601 MARKET STREET, SUITE 2400, PHILADELPHIA, PA, 19103-2307, US

(21) Appl. No.: 11/875,807

(22) Filed: Oct. 19, 2007

Related U.S. Application Data
(60) Provisional application No. 60/862,150, filed on Oct. 19, 2006.

(51) Int. Cl. G06K 7/00; G06K 19/07

(52) U.S. Cl. 340/572.4; 340/10.3

(57) ABSTRACT

The present invention provides various techniques to improve the security of data transmissions in RFID systems. Systems and methods for constructing more secure RFID tags, readers, and servers are disclosed enabling individuals to minimize privacy exposure while taking care to avoid needlessly overcomplicating the user's RFID transactions.

### PRIORITY CLAIM

This application claims the benefit of priority to U.S. Provisional application 60/862,150 filed Oct. 19, 2006, and the entire disclosure of which is incorporated by reference.

### FIELD OF THE INVENTION

This invention relates to methods and systems for improving the security of data transmissions between tags and readers in an RFID system.

### BACKGROUND

Radio Frequency Identification (RFID) is a technology that allows for the electromagnetic transfer of information to and from a remote tag or transponder that is affixed to an object. Upon receipt of the information, a tag will often read from or write data to its memory. Details concerning the electrical and magnetic circuitry that allows for this electromagnetic exchange of information may be found in patents such as U.S. Pat. Nos. 5,053,774 and 5,121,407, but many other RFID systems may be used.

RFID has many useful applications, and the expected ubiquity of RFID has raised concerns about users' personal privacy. Many existing commercial RFID systems are not secure and the limited security they may provide often makes using the systems more difficult. The prospect of a spy being able to wirelessly download all of a store's inventory, a thief being able to scan the items in a home or in a car, or a stranger scanning someone's mail are all important concerns that so far have largely gone unresolved.

A) Description of RFID Tag Circuitry

To understand how the present invention works, it is useful to have at least a basic understanding of the technology behind RFID. As shown in FIG. 1, an RFID tag or transponder 100 comprises a transmitter 110, a receiver 130, a processor 150, and a memory 170 used for storing information such as the tag's identification number. FIG. 2 shows a reader or interrogator 200 comprising a transmitter/receiver 220, a display 230, and a keyboard 250. In FIG. 1, the transmitter 110 allows the tag 100 to send or transmit a modulated signal to reader 200. The receiver 130 allows the tag 100 to capture or receive a modulated signal sent by the reader 200. Often, the receiver 130 will include a demodulator and detector for demodulating the RFID signal. The signal contains a modulated message which may contain one or more commands for the tag 100. Once the receiver 130 has demodulated the reader's signal, the receiver sends the message to the processor 150 through the receiving electrical conduit 135. When the processor 150 receives the message, it may execute certain commands to read or write information to the memory 170 upon receipt of the signal. The processor 150 may also contain an error checking circuit 151 for determining whether the demodulated message contains any errors. A protocol for implementing an error checking circuit is discussed in the EPCglobal Class 1 Generation 2 UHF Air Interface Protocol Standard, v. 1.0.9 (“Gen 2 Specification”), which is incorporated by reference. The signal may also contain instructions for the tag 100 to transmit certain information back to the reader 200. In other configurations, the tag 100 has built-in instructions to take certain actions or make certain transmissions upon receipt of predetermined instructions from a reader 200. In either case, the commands in the message may cause the tag 100 to backscatter a message or signal back to the reader 200. In some configurations, the processor 150 will read and/or process information from the memory 170, and send a message possibly containing commands through the transmitter's electrical conduit 115 to the transmitter 110. The transmitter will then modulate the message into an RFID signal, and use an antenna or coil 116 to send the modulated message to the reader 200.

B) The EPCglobal Gen 2 specification Many prior art RFID tags comprise different codes containing information about the tag. For example, in the Gen 2 Specification, a compliant RFID tag comprises the following codes: an EPC, a PC, and a CRC-16. An EPC is an electronic product code that identifies an object to which a tag 100 may be attached. If the tag is not attached to an object, the code may simply identify the tag itself. The PC (product control bits) contain physical-layer information that a tag backscatters with its EPC during an inventory operation. The CRC-16 is a cycle redundancy check that tags and readers use to verify that commands and messages are successfully received. More information on these codes is readily obtainable from the Gen 2 Specification. An important difference between the EPC and the other two codes (the PC and the CRC-16) is that the EPC is the only code used to identify the tag. Thus, when a reader is requesting the identity of a compliant Gen 2 tag, the reader is actually requesting the EPC of the tag.

According to the Gen 2 Specification, the electronic product code is stored in the EPC memory beginning at address 20ₕ. A compliant Gen 2 reader has a number of commands it can use in conjunction with the EPC. For example: a reader 200 may issue a SELECT command that includes all or part of the EPC using a mask; a reader 200 may use an ACK command to cause a tag to backscatter or send its PC, EPC, or CRC-16; or a reader may issue a READ command to read all or part of the EPC. In the Gen 2 Specification (and all other RFID systems known to the inventor) a tag has one and only one identity, the EPC.

C) Discussion of Current Security Problems Relating to the Exposure of Tag Identities

A problem with having only one identity is that the tag is easily traceable. To solve this problem, others have proposed rewriting the tag's identity each time the tag is moved into a new environment. This solution is not without its flaws as access to the database may be compromised or the database itself may be damaged resulting in a vast amount of leaked or lost data. In addition the remapping process is time consuming and often labor intensive.

In the abstract, maintaining a mapping database for changing tag identities does not sound particularly difficult, but when one considers databases such as the Savant system disclosed in U.S. patent application Ser. No. 10/769,292, which may perform thousands of operations per second, the additional burden of having to keep track of changing EPC's would greatly slow down the system. In today's market where customers demand real time access to data, solutions that slow down databases with extra information to store and backup are generally avoided. For at least these reasons, the RFID market has been slow to adopt RFID systems that use mapping databases, and has continued with the basic one-tag, one-identity model for increased speed and efficiency, even at the expense of security and privacy. Improving the security and privacy of RFID tags without comprising the speed or efficiency of the RFID system, is a major goal of the present invention, but before revealing how the present invention works, an example of how warehouses and stores keep track of their goods may be helpful to understand the context of the present invention.

When a store or warehouse receives products with attached tags 100 that have an EPC 171 as their identity, the store can use an RFID reader 200 to query the tag's identity 171. Upon interrogation by a reader 200, the tag will backscatter its identity 171 back to the reader 200. Using ONS, (object naming service) the store can look up the item's description to determine the item that corresponds to this tag. Such a system is very insecure, because anyone with an RFID reader can gain access to the tag. A potential competitor could walk through the store capturing EPC's, or a potential thief could determine what items are in a potential victim's bag or locker.

To reduce this risk and other security risks, some stores use a mapping database. In such a system, the store receives a pallet of products from its supplier. For example, presume the store receives fifty cases of beer. A store employee using a keypad 250 on an RFID reader 200 will key in data like the brewery, brand, price, quantity, and the sell-by date for the beer. Then the employee uses the reader 200 to program a new identity for each of the RFID tags on the beer. Using a singulation technique like “tree walking” or ALOHA, the reader will query each transponder 100 and store them into some sort of list which may be visible on the reader's display 230. The user can then upload the list and keyed data to a secure server. When a customer offers to buy the item, the merchant's reader at the point of sale (POS) station will query the tag, receive the new identity of the tag, and look up the tag's EPC using the mapping database. There are two problems with this system. First, the store has to spend a lot of time reprogramming the tags and storing the reprogrammed tags into the merchant's database, and second, the database itself may be stolen or damaged. Companies with large buying power like Home Depot® or Walmart® can force their supplies to place their internal codes onto the RFID tags, but this raises supplier costs, and does not solve the problem of possible database corruption or theft.

D) Singulation Techniques

Soon after RFID transponders were invented the problem with electromagnetic transponder collisions was soon realized. If a reader queries more than one transponder in a given field by issuing a general request for all the transponders in field to respond, the transponder's all backscatter their IDs to the reader at the same time. The backscattered RF transmissions interfere with one another, and reader cannot properly demodulate the transponders' transmissions. Singulation refers to the implementation of a technique to deal with this problem. Though there are many singulation techniques described in the patent literature, many of them are based on two concepts: Tree Walking and or ALOHA.

Tree walking involves sending a transmission to all tags with an ID beginning with 1 or 0 to respond. If the reader receives more than one response, the reader sends a transmission for all tags with an ID beginning with 11 or 10 to respond. If the reader gets more than one response, then the reader requests all tags with an ID beginning with 110 or 111 to respond. The process continues until one tag responds. The reader than continues following the “tree” by requesting all tags on the next branch to respond. In this case, perhaps the reader would request all tags an ID beginning with 101 or 100 to respond. The process continues until all the tags in the field respond. There are a number of ways to optimize this scheme including ways to temporarily silence tags that have already responded. This technique can be executed very quickly, but it leaks considerable information, because an eavesdropper can use another receiver to capture all the singulation attempts. This privacy danger is particularly severe when the singulating reader has a limited list of branches to try or knows a portion of the ID of the tag before singulating. There are a number of ways to reduce the exposure and efficiency of the Tree Walking schema. Many of these techniques can be found US Patent Application Publication 2007/0057791 owned by IBM and is incorporated by reference. A completely different technique to avoid this privacy danger is called ALOHA, but this technique cannot be performed as quickly as Tree Walking so the additional privacy offered comes at a cost of efficiency.

In ALOHA the tags or reader detects when a collision occurs, and the attempt to retransmit the information after a random interval. Like, Tree Walking, there has been many improvements on the basic ALOHA schema, such as U.S. Pat. No. 6,784,787 owned by Zebra Technologies, Inc., and incorporated herein by reference. In that patent, the tags transmit their response and then wait for an acknowledgment transmission from the reader. The tags wait for a random amount of time and resend the response if they do not receive the acknowledgment. The patent also discloses a method to have the tags adjust the response window they select when replying to decrease singulation time.

Though there has much work in developing better and faster singulation techniques, there is still room for improvement. Several aspects of the invention relate to providing improved singulation techniques which help reduce the exposure of a tag's identity.

E) ONS Security

The present invention relates to various techniques for improving the security of RFID tag and reader interactions will be presented. Improving the security surrounding these transaction may leave the data network to be the weakest security link the present invention. While the present invention provides techniques to reduce the ability of an attacker to glean information from the Tag's ID, an attacker could still learn information about the tag during the tag ONS lookup process. ONS or Object Name Service is an “automated networking service similar to the Domain Name Service (DNS) that points computers to sites on the World Wide Web. When an interrogator reads an RFID tag, the Electronic Product Code is passed to middleware, which, in turn, goes to an ONS on a local network or the Internet to find where information on the product is stored. ONS points the middleware to a server where a file about that product is stored. The middleware retrieves the file (after proper authentication), and the information about the product in the file can be forwarded to a company's inventory or supply chain applications.” RFID Journal. “What is the Object Naming Service?” Oct. 16, 2007.

A common type of attack against many communications protocols such as ONS is the Man-In-The-Middle (MITM) attack. As an example, consider two users Alice and Bob, who wish to communicate securely using public key cryptography. Alice and Bob implement the following protocol to “securely” communicate: 1) Alice sends Bob her public key, 2) Bob sends Alice his public key, 3) Alice encrypts her message with Bob's public key and sends it to Bob, 4) Bob decrypts the message with his private key and reads it, 5) Bob encrypts his message with Alice's private key and sends it to Alice, and 6) Alice decrypts the message with her private key and reads it.

This simple exchange seems secure, but is very vulnerable to a simple attack by a third user “Mallory”, a malicious attacker. The vulnerability of Alice's and Bob's communication is illustrated in the following steps: 1) Alice sends Bob her public key. Mallory intercepts Alice's key, and substitutes his own public key. 2) Bob sends Alice his public key. Mallory intercepts Bob's key, and substitutes his own public key. 3) When Alice sends a message to Bob, Mallory intercepts the message and decrypts it using his private key. Then he encrypts the message using Bob's public key and sends it to Bob. 4) When Bob sends a message to Alice, Mallory intercepts the message and decrypts it using his private key. Then he encrypts the message using Alice's public key and sends it on to Alice.

Mallory is now able to see and modify any messages that Bob sends to Alice and vice versa. This is a problem in any case where data integrity is important. In the case of ONS using public cryptography, this might be a big concern because the information is often linked to things of value. The easiest way to solve this problem is to use DNSSEC's authentication mechanism, which prevents DNS clients from being hijacked.

DNSSEC focuses on preventing DNS poisoning attacks, which are ones where a misconfigured server is convinced that incorrect records are authoritative. Since this information is cached, it can spread to any servers and clients that use that server. The signature and authentication chain of DNSSEC can quickly detect and remove from the cache any non-authoritative data that does not have the proper signatures, making the problem moot. Unfortunately, DNSSEC does not obscure information, allowing an attacker to learn EPCs or Tag IDs even if the server cannot be fooled into believing the message sent by Mallory came from Alice. A user in the middle of the exchange of the ONS lookup or Tag ID lookup can still learn the EPC or Tag ID information.

To reduce this vulnerability, The Onion Router, also known as TOR was developed. TOR is a cryptographically protected anonymous proxy system, focused on web applications. TOR uses three intermediate proxy servers with encrypted links to make determining the originating host difficult unless a significant number of the proxy servers have been compromised. Unfortunately, since the service is used to access web pages, it must create virtual TCP circuits and maintain state. This makes traffic analysis a possibly reasonable attack for associating a client with an access.

To use TorONS a user (client) follows the following nine step process. 1) A client connects securely using public key cryptography to a directory server. 2) The directory server returns the public keys of three different Tor proxy servers. 3) The client generates an Onion routing packet which has each link in the route encapsulated by the public key for the current node. 4) The client sends the Onion routing packet to the first node. 5) The first node decrypts the first layer of the Onion routing packet which tells the IP address and public key of the second node. 6) The first node forwards the decrypted Onion routing packet to the second node. 7) The second node decrypts the first layer of the Onion routing packet which tells the IP address and public key of the third node. 8) The second node forwards the decrypted Onion routing packet to the third node. 9) The third node decrypts the first layer of the Onion routing packet which tells the IP address of the destination. While the attacker might not be able to learn who requested the information, the attacker may be able to analyze the ONS lookups to make an educated guess.

After significant experimentation using the TOR specification and software, an ONS system (“TOR-ONS”) using TOR was developed. A similar system could be constructed for performing generic Tag ID lookups. The TOR-ONS system is capable of reducing a number of security risks, but there is still a security vulnerability remaining. If one of the servers that the user communicates with has been hacked into or is leaking data to third parties, the ONS lookups or Tag Id lookups of a user may be compromised. The potential value of knowing the location, shipping information, or value of a store's inventory makes this potential vulnerability a significant security risk motivating unscrupulous attackers to infiltrate TOR servers. Additionally, the owners of the TOR servers may find their scruples strained and find themselves willing to part with the information streaming across their servers for the right price. However, since TOR utilizes multiple anonymous servers, learning which server leaked or sold the information becomes quite difficult. The present invention provides a solution to this problem, by way of a technique referred to as ID misdirection.

### SUMMARY OF THE INVENTION

To improve the security problems associated with known RFID systems, the present invention provides a secure solution that allows an EPC or other identifying data to be stored on a tag without compromising the tag owner's privacy. The present invention my embodied in nearly all types of RFID systems such as systems that: 1) track and monitor the location or condition of an object or a pallet; 2) identify or track living objects (such as cattle, pets, or humans) via attachment of an RFID tag to the living object; 3) may be used in point of sale transactions where RFID tags are attached to objects that are for sale; 4) display or determine identification of a card holder via incorporating an RFID tag into an electronic identification card or key fob; 5) provide prescription drug information; or 6) are designed to prevent or reduce the distribution or sale of counterfeit products.

One way to improve the security of an RFID system is to design a transponder which has two identities. The first identity may be a public identity that any RFID reader can access. The second identity might be the tag's real identity (perhaps its EPC), and this identity would usually only be exposed to an authenticated reader. Some embodiments of this tag may also have one or more hashlocks for restricting access to data on the tag.

To use a transponder having two identities, an authenticated reader would query the tag. The tag may reply with its public identity. The reader might then transmit the tag's public identity to a server which can look up the tag's public identity in a database. Using the public identity as a key, the server may compute one or more hashlocks and send the authenticated reader the result. Depending on the operation desired, the reader can select one of the results from the hashlock computation to tag. In some embodiments the reader may also send additional information to the tag along with the result. Upon receipt of the result and the additional information (if sent), the tag may execute a program in memory causing the tag to perform a certain operation. For example, the tag might backscatter the real identity back to the reader or change the public identity to a new value.

Another aspect of the present invention relates to an RFID controller. An RFID controller can be used to change the public identity of a tag or change the hashlocks or secrets on a tag. RFID Controllers may also be used to store tag information. In certain configurations controllers may be assembled to interface with RFID receptacles or receptacle servers. These two devices may be used, for example, in the home or office for interfacing with RFID tags. An RFID controller can be used to upload information about the tag, so that the receptacle or server can retrieve product information that may relate to a tag's real identity.

The present invention can also be used to enable a secure electronic transaction using RFID using a transponder. The transponder can be used alone or integrated onto a credit card. Methods of using this transponder are also presented. One method discloses providing a transponder capable of enabling or disabling electronic transactions, and an RFID controller for interfacing with the transponder is also provided. One can use the controller to transmit a signal to the transponder, which causes the transponder to enable electronic transactions. Additionally, various methods of enabling and disabling the transponder are presented.

Another aspect of the present invention relates to electronic receipts. A buyer or seller engaging in a transaction often issues the other party a receipt to describe the purchase. An aspect of the present invention is to provide an RFID controller capable of digitally receiving and storing the electronic receipt. The controller may comprise computer executable code containing instructions for causing the RFID controller receive an electronic receipt from an RFID reader, save the electronic receipt in memory; and restrict read access to the memory storing the electronic receipt. Additionally, the code may require the user to enter identification information into the controller to read data that has been saved.

Another aspect of the present invention relates to the providing techniques to prevent an attacker from successfully issuing unauthorized commands to a group of tags. This aspect of the invention provides ways to protect privacy data when performing singulation routines; ways to determine whether a command originated from an authorized reader, ways to protect tags from executing unauthorized commands, ways to implement a transponder timer; ways to slow down a reader's ability to issue commands.

Another aspect of the present invention relates to the controlling access to tag commands. This aspect of the invention provides a way controller which reader or controller can send commands to a tag. In this system a server may keep a list of which controller can send which commands to which tags. Additionally, one advantage of this system is that it can be configured to encrypt commands so that neither the reader nor the controller will know the secret of the tag.

Another aspect of the present invention relates to techniques for determining whether unauthorized individuals are monitoring ONS lookups. These techniques also provide ways for determining the identities of these individuals. In addition, specialized tags can be developed which can help expose the presence and identity of individual conducting ONS lookups on a user's tags.

### BRIEF DESCRIPTION OF THE FIGURES

FIG. 1 is a schematic view of prior art RFID transponder.

FIG. 2 is a schematic view of prior art RFID interrogator.

FIG. 3 is a schematic view of an RFID transponder according to the present invention.

FIG. 4 is a flow diagram showing the transmission of data between the RFID tag of FIG. 3, a reader, and a server.

FIG. 5 is a schematic view of the memory of an RFID transponder illustrating three hashlocks and two identities.

FIG. 6 is a schematic view of a Tag Folio controller.

FIG. 7 is a flow diagram showing the transmission of data between an RFID tag, reader, a Tag Folio controller, and a server.

FIG. 8 is a schematic view of a RFID Receptacle.

FIG. 9 is a schematic view of a Receptacle Server system.

FIG. 10 is a schematic view of a credit card with a transponder.

FIG. 11 is an enlarged schematic view of the transponder of FIG. 10.

FIG. 12 is a flow diagram of a method of using a credit card having a transponder.

FIG. 13 is a flow diagram of a method of enabling a credit card having a transponder.

FIG. 14 is a schematic vie of the Tag Directive system.

FIG. 15 is a flow diagram for a method of using the Tag Directive system.

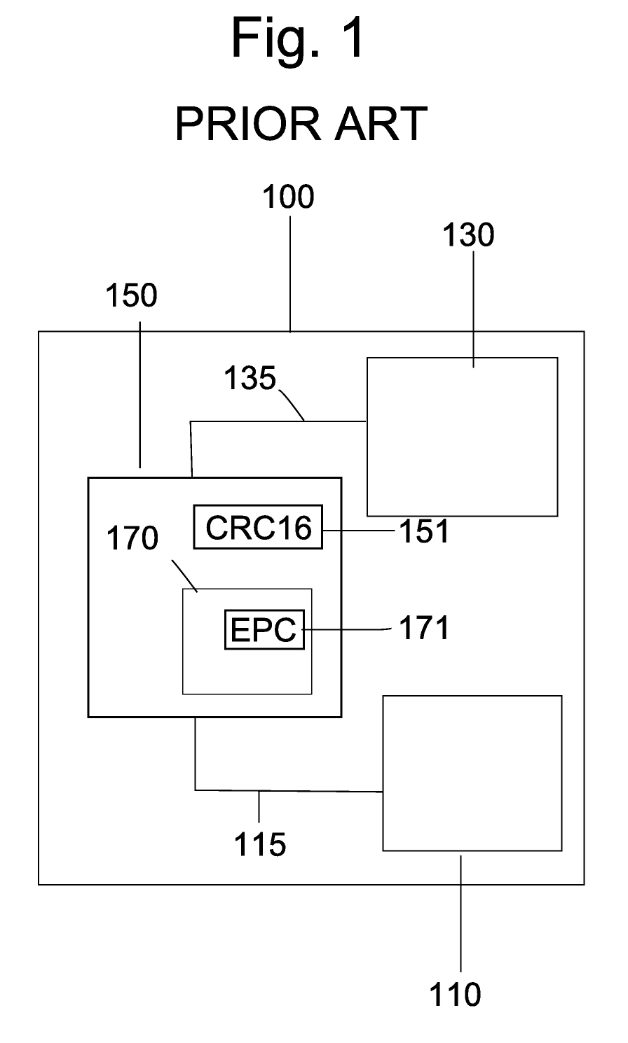

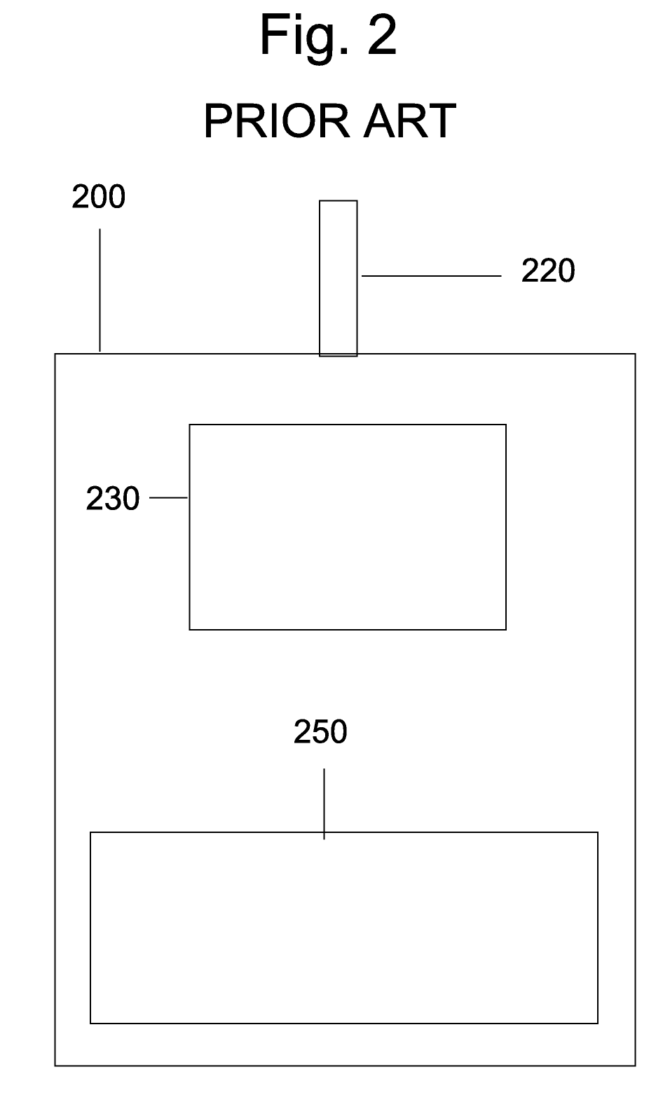

### DETAILED DESCRIPTION OF THE INVENTION

The present invention relates to methods, apparatuses, and systems for improving the security of RFID technologies. The systems, methods, and apparatuses may be used in operations such as transferring ownership of an RFID tag, reading or writing to a tag's memory, silencing or killing a tag, or preventing access to a tag. Section I discloses the Janus Tag System which features an RFID tag having two identities. Section II discloses the Tag Folio system which features a controller that allows a user to manipulate a tag's security features, and allows for the storage and transmission of tag information. This section also discloses systems and methods for using RFID tags with a receptacle sever or RFID receptacle. Section III discloses Tag Seal which may be used in conjunction with Tag Folio. Tag Seal provides techniques for using RFID to enable electronic transactions. Particularly, in some configurations, Tag Seal may be used to enable credit or debit card purchases by transferring account codes (credit or debit card numbers) and authorizations through radio frequency transmissions. Section IV discloses an electronic receipt system which allows a Tag Folio Controller to receive and store electronic receipts from an RFID reader. Section V discloses the Tag Shield system which provides different techniques for preventing or reducing the ability of an attacker to issue unauthorized commands to a group of tags. Section VI relates to methods and systems for controlling access to tags via a technique called Tag Directive. Section VII discloses a technique called ID misdirection which utilizes fake ONS lookups to allow ONS users to determine the identity of anyone looking up their EPC identifiers. This section also discloses specialized RFID tags that can help expose the presence and identity of individuals making ONS lookups on a user's tags.

I) Janus Tags

A) Structure of Janus Tags

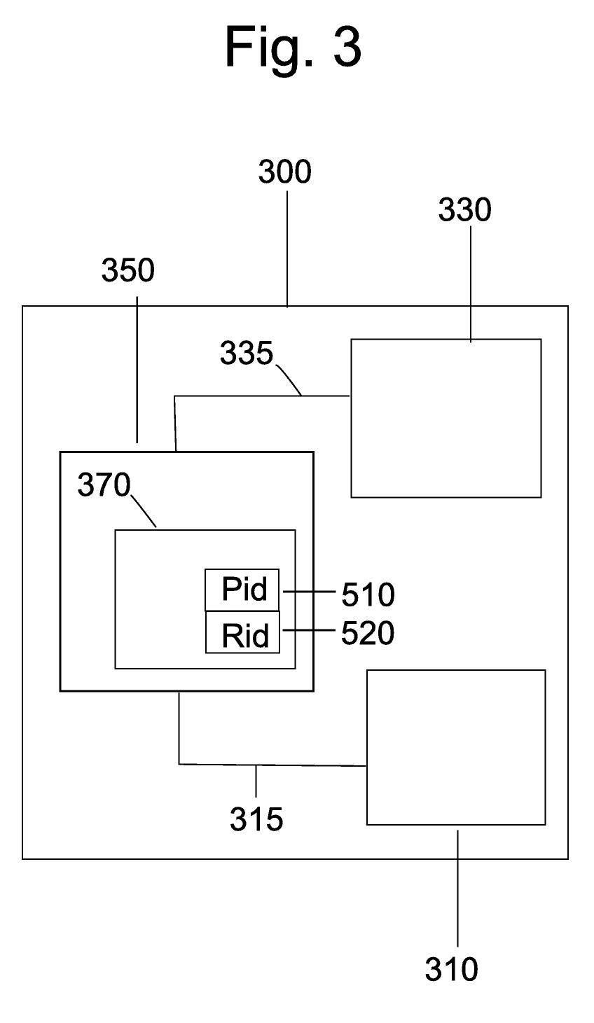

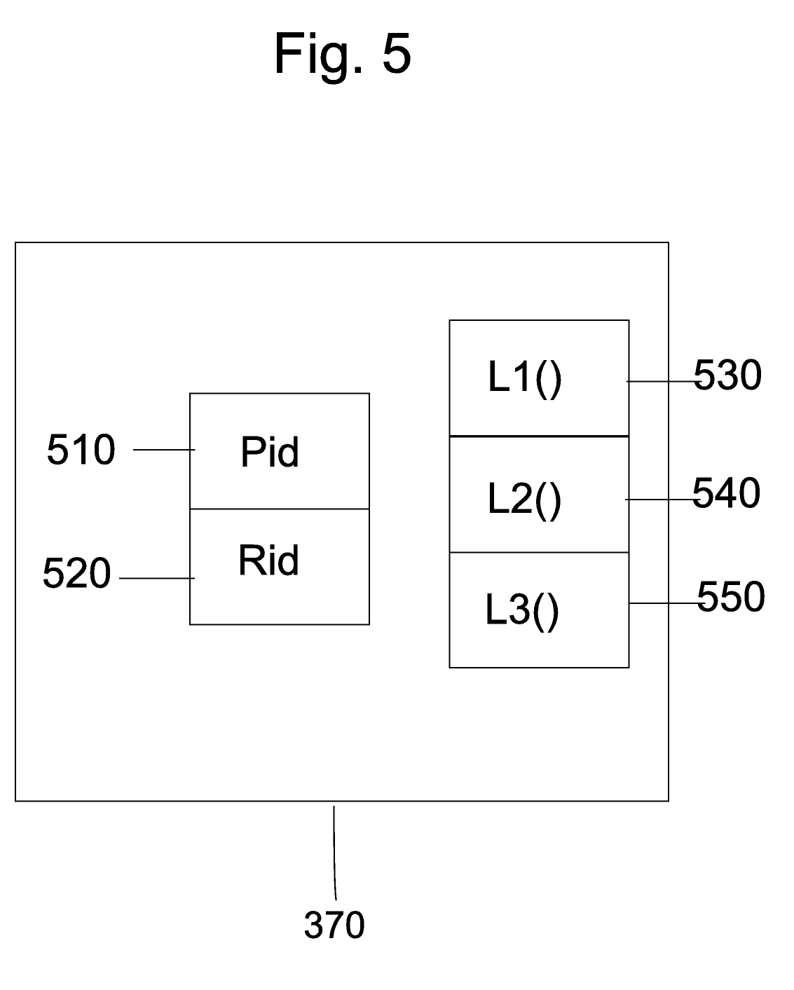

The Janus Tag system utilizes specialized tags hereinafter referred to as Janus Tags. As shown in FIG. 3, a Janus Tag is a tag 300 having two identities each of which has a different purpose. In the configuration of a Janus Tag shown in FIG. 3, the tag 300 comprises a transmitter 310, a receiver 330, receiving and transmitting electrical conduits 315 and 335, a memory 370, a processor 350, and a hashlock (not shown) stored in the memory. As shown in FIG. 5, the memory 370 of Janus Tag 300 also comprises two identifying codes in memory P_{id} 510 and R_{id} 520. Each identifying code provides the tag with a different identity. In some configurations, either identifying code is capable of allowing a reader to uniquely identify the tag. The codes can be stored in binary, hexadecimal, or any other numbering format, and may also contain numbers, letters, and symbols. In many configurations, the two identifying codes will be set to different values.

The first identity code, P_{id}, is shown to an unauthenticated reader. In some configurations the first identity is changeable. The second identity, R_{id} is a private identity visible only to authenticated readers. In some configurations, the second identity is static or designed not be changed. A tag 300 will provide a P_{id} to any reader 200 that singulates the tag 300, unless that tag has been silenced or killed. In most configurations, a Janus Tag will not reveal its real identity (or the fact it has more than one identity) to an unauthenticated reader can only access P_{id}. Although, in some configurations, the Janus Tag may be placed in an unlocked mode which would reveal the R_{id}-Janus Tag 300 may be equipped with one or more secrets and one or more hashlocks. A secret is a number that is kept secret from an RFID reader 200 which is involved in processing the hashlocks. Hashlocks are generally complicated, one-way functions that rely on a secret number to compute an answer. Hashlocks often employ the use of hash functions, hence the name. Various types of hashlocks can be used in the Janus Tag System, such as the AES or DES block ciphers. See “Announcing the Advanced Encryption Standard (AES)” and the “Block Ciphers”, incorporated by reference, for more information. Systems and methods for using a tag's hashlock, changing a tag's hashlocks, and utilizing a tag's secret are disclosed in the Tag Folio section below.

Janus Tags may also be equipped with some object code which is designed to be executed by the processor 350. Many different programs could be written, and the code sample provided below (written in pseudocode) is exemplary only as other languages and codes may be suitable depending on the tag's circuitry or desired capabilities (italics denotes comments that are not to be executed).

1. my @command = getReceivedTransmission( );

Calls a method to store the result of the reader's transmission as an array
called command.

2. my $answerL1 = L₁(s|P_{id}); my $answerL2 = L₂(s|P_{id}); my $answerL3 = L₃(s|P_{id});

compute L₁( ), L₂( ), and L₃( ) using the public identity and the secret.
Secrets are discussed later in the Tag Folio section. Store the result as
$answerL1, $answerL2, and $answerL3.

3. use constant CHANGE => 0; use constant SILENCE => 1; use constant KILL => 2;

declare constants for use when L₃ is transmitted.

4. if ($command[0] == null) return P_{id}.

If not hashlock result is sent, return the P_{id}.

*******FIRST HASHLOCK FOR CHANGING P_{ID}********
5. if ($command[0] == $answerL1) {

P_{id} = $command[1];
return P_{id}.

}

Here if the reader transmits $answerL1 to the tag, the tag will overwrite
the P_{id} with the value saved in $command[1].

*******SECOND HASHLOCK FOR TRANSMITTING R_{ID}********
6. if ($command[0] == $answerL2) {

return R_{id}
}

If L₂ is transmitted, the tag will transmit the R_{id} to the reader.

*******THIRD HASHLOCK FOR CHANGING THE HASHLOCKS,*******
*******SILENCING THE TAG, OR KILLING THE TAG. *******
7. if ($command[0] == $answerL3) {

| | |
|---|---|
| A. | if ($command[1] == CHANGE){ |

for (my $i=0; $i<3; $i++){

H(l_{$i}) = $command[2 + $i]

}
If L₃ is transmitted with the CHANGE command specified, the tag will
change the hash locks of the tag. In this case the reader would transmit
the new hash locks to the tag.

| | |
|---|---|
| B. | if ($command[1] == SILENCE){ |

tag sets itself to silent mode and returns 0;

| | } |
|---|---|
| C. | if ($command[1] == KILL){ |

tag kills itself and returns 1;

}

}

B) Uses of Janus Tags

Through interaction with the reader 200, server 400, and a Tag Folio Controller (discussed in the Tag Folio section), data sent to the tag 300 is processed and run through the code above. For example, when a merchant receives one or more Janus Tags, the merchant will assign a proprietary numbering system for the value of the P_{id}. Without a lookup table, which the merchant might store on a secure server, this number is not useful to a person who might eavesdrop on the merchant's tag or reader. The merchant does not need to save any product data associated with the P_{id}, because the merchant can use this P_{id} as a key to determine which hashlocks secure the tag. With the tag's real identity stored on the tag, the merchant can access the real identity by performing an decrypt operation (step 5 in the pseudo-code) with an authenticated reader 200. The R_{id} will provide the code necessary to determine the manufacturer, model, and price of the item. The merchant's server may have information relating to that R_{id} number or the reader could use ONS to look up the information. For example, all R_{id}'s having the serial number 10101101110110 may be six-packs of Brand-X beer cans, costing $5 each. The merchant's reader could also use ONS to look up this information on the internet if the R_{id} is an EPC. (See the “Object Naming Service Specification” published by EPCglobal and incorporated by reference). If a person uses an unauthenticated reader to read the tag, he or she will only be able to retrieve the P_{id}, which is not mapped to any data the person or reader can retrieve.

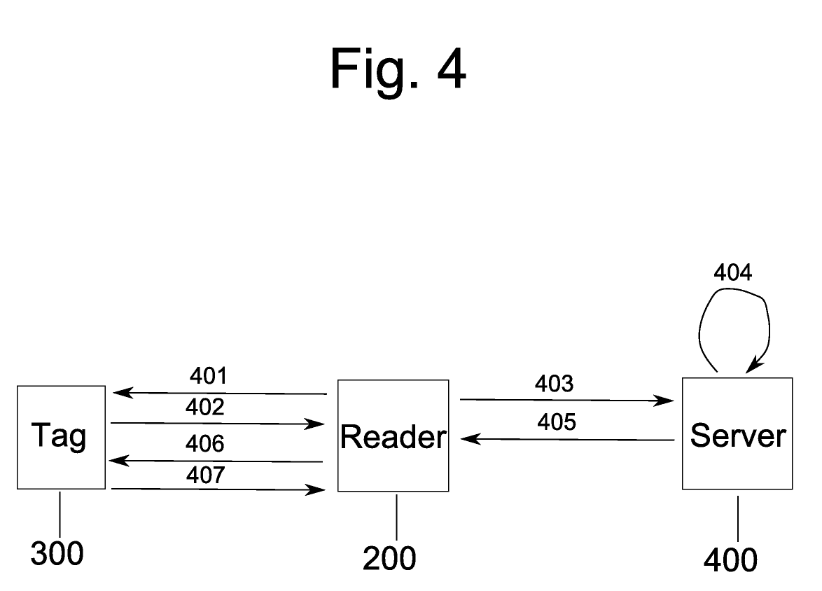

A person using an authenticated reader can retrieve information from the Janus Tag 300 by using the reader 200 to send a query to the tag 300, as shown in FIG. 4, step 401. The Janus Tag 300 sends its P_{id} back to the reader 200, step 402. The authenticated reader 200 then transmits the P_{id} to a secured sever 400, step 403. Reader-server authentication may be achieved through various wire line protocols including SSL or digital certificates. If the reader 200 is not authenticated, the server 400 will refuse to send the reader 200 any information about the tag 300. If the reader 200 is authenticated, the server 400 will look up (step 403) the tag's hash locks L₁( ) 530, L₂( ) 540, and L₃( ) 550 in a database 500 using the P_{id} as a key. See FIG. 5. Systems can be made using one, two, three, or more hash locks. To implement the Gen 2 Specification, only two hashlocks would be needed: one for unlocking the tag, and one for killing the tag. Moreover, a system using one hashlock to control all access could be used. A one or two hashlock system lacks a certain amount security granularity. Systems having four or more hashlocks may have more granularity than is desirable, overcomplicating access to the tag. The use of three hashlocks allows for the separation of operations into three common types of access required when using a Janus Tag: 1) changing its P_{id}, 2) disclosing its R_{id}, and 3) changing ownership of the tag, silencing the tag, or killing the tag.

As previously mentioned, the server 400 looks up the tag's hashlocks in a database by using P_{id} as a key. The server performs L_{1,2,3} (s|P_{id}) and returns (step 405) the result (L₁′, L₂′, L₃′) to the reader. The server does not transmit the hashlocks to the reader, only the result.

Once the reader knows L₁′, L₂′, or L₃′, the reader 200 can transmit (406) one of the three numbers to the tag to cause the tag to backscatter information or write information to its memory.

If the merchant needs access to the tag's R_{id} to look up the price or item description via ONS, the reader 200 must transmit L₂′ (step 406) to the tag 300. Once the tag 300 receives L₂′, it will backscatter (step 407) the R_{id} to the reader 200. The merchant now has access to the R_{id} and can complete the sale.

If the merchant wants to change or mask the P_{id} for the purchaser, the merchant can optionally change the P_{id} to another number (perhaps a random one) by transmitting L₁′ and new P_{id} to the tag 300 using the reader 200. After changing the public identity of the tag, the customer can leave the store with a product having a tag with a new P_{id} that has no meaning, and the customer's privacy is secured, because the R_{id} of the tag cannot be discerned without knowing the hashlocks for the tag 300. Because each tag has a different set of hashlocks, brute force attacks against the tag will not be effective to access the R_{id}.

A related method for changing the P_{id} of a Janus Tag involves a technique called cloaking. In this technique, the merchant's reader listens for other tags backscattering their P_{id}'s within the reader's EM field. The reader then stores one of these eavesdropped P_{id}'s in memory. When the merchant's reader scans a new tag, it may change the tag's current P_{id} to the eavesdropped P_{id} after the reader has collected the tag's original P_{id}. The reader can use the eavesdropped P_{id} a certain number of times, for a certain period of time, or change the eavesdropped P_{id} that is stored in memory every time the reader captures a new P_{id}.

One shortcoming of using the Janus Tag system alone is that the customer will not be able to make use of any SMART receptacles like RFID appliances or containers, because the customer does not know the hashlocks to the tag and does not have the tag's R_{id}. These shortcoming are addressed and remedied with the Tag Folio system which can be used with the Janus Tag system.

II) Tag Folio

Tag Folio provides systems and methods for initializing and transferring the secrets of a tag. The Tag Folio system also includes the use of an authorized intermediate controller (called a Tag Folio Controller) useful for storing data, transferring information, and changing hashlock codes on tags. Methods for making and using the Tag Folio Controller (TFC) and the Tag Folio system are described below.

A) Structure of the Tag Folio System and Tag Folio Controller

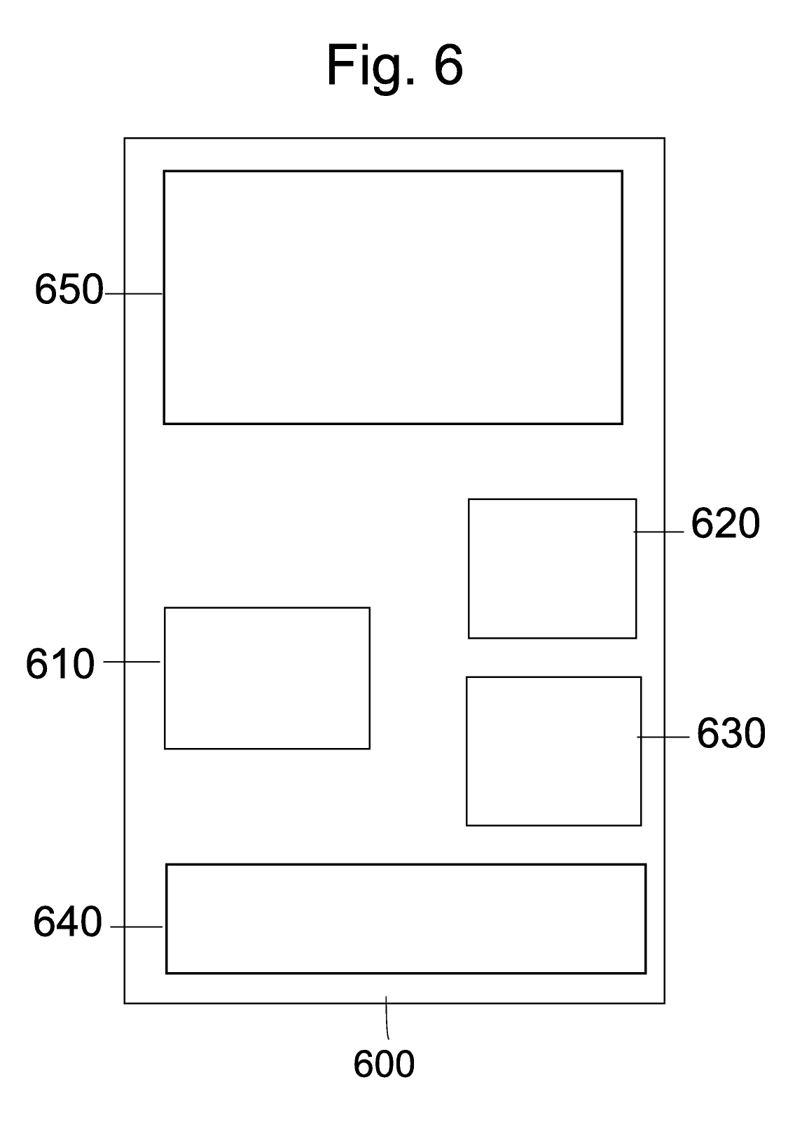

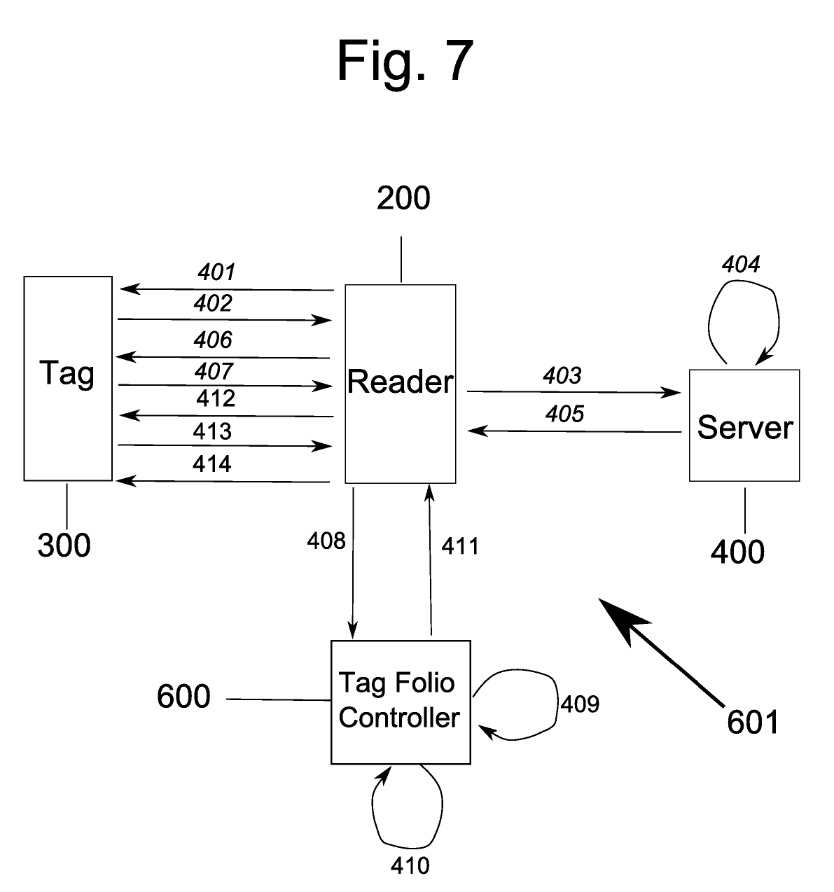

A Tag Folio system 601 may comprise a reader 200, server 400, tag 300, and a TFC 600. The Tag Folio Controller 600 may be embodied as a cell phone, PDA, laptop, computer, or other electronic device containing a controller memory 610, a communicator 620, and a controller processor 630. See FIG. 6. Unlike the reader 200, server 400, or the tag 300, the TFC 600 will usually be owned or controlled by the purchaser of tag. In a configuration where the TFC is embodied as a cell phone, most systems would use the merchant's reader, server, and tag, but use the buyer's cell phone. As will become apparent from the following description, it is the TFC which will keep track of the tag's new hashlocks and real identity. The communicator 620 is designed to securely connect to a reader 200 using SSL, Bluetooth, digital certificate exchange, or other secure technologies. See FIG. 7. The connection to the reader 200 may use wireless or wired systems. Additionally, the TFC 600 may contain a keypad 640, and a controller display 650 as shown in FIG. 6. Some embodiments of the TFC 600 may utilize biometric authentication, voice authentication, or other security features.

B) Using the Tag Folio Controller During a POS Transaction

Referring now to FIG. 7, the Tag Folio system 601 allows a user to change the hashlocks on a tag. To do so the first seven steps discussed in the Janus Tag section above should be followed. (These steps are shown in italics in FIG. 7.) Once the reader 200 receives the tag's R_{id}, the reader 200 will then send the R_{id} to the Tag Folio Controller 600, step 408. The Tag Folio Controller 600 may then generate a new Public Identity P_{id}′ (step 409) or a new set of hashlocks for the tag, L₄( ), L₅( ), and L₆( ), (step 410) or both. The TFC 600 may then transmit P_{id}′ and/or the new hashlocks to the reader 200 (step 411). As described in the source code in the Janus Tag section, to change the P_{id} of the tag, the reader 200 must transmit L₁( )′ (which the reader has from step 406) and the new public identity (from step 411) to the tag (step 412), unless different tag software code is written to the tag. Pursuant to step 5 of the code, the tag will return the new public identity, P_{id}′ to the reader 200 upon successful completion of the reprogramming (413). As called for in step 7 of the code, to change the hashlocks of the tag, the result L₃( )′ is transmitted along with the three new hashlocks L₄( ), L₅( ), and L₆( ) (step 414) to the tag. Additionally, as provided in steps 7B and 7C of the code, the customer can also silence or kill the tag by using the appropriate command with the L₃( )′ hashlock.

It is envisioned that some merchants may wish to provide a second RFID reader (perhaps a gateway) to allow customers to verify that the public identity of the tag was changed. Some embodiments of a Tag Folio Controller 600, may have their own integrated reader to make this type of verification.

C) Using the Tag Folio Controller at Home

When the customer or user takes the RFID tag and the associated object home, the customer can use the Tag Folio Controller 600 to make use of (or de-silence) the tag.

When a customer takes the tagged object to his or her home or office, the user might not be able to use the tag, because the merchant may have altered the P_{id} to a random value or to a value unrelated to the product. However, if the customer used a TFC 600 when purchasing or obtaining the tagged object, then he or she will be able to RFID devices with the RFID tag.

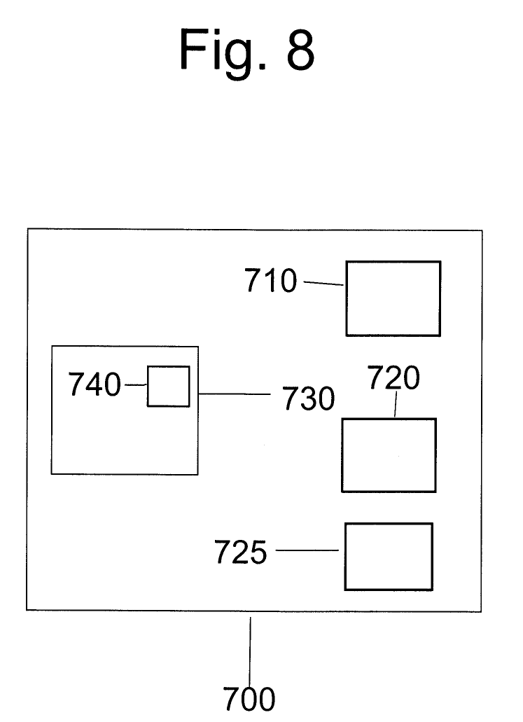

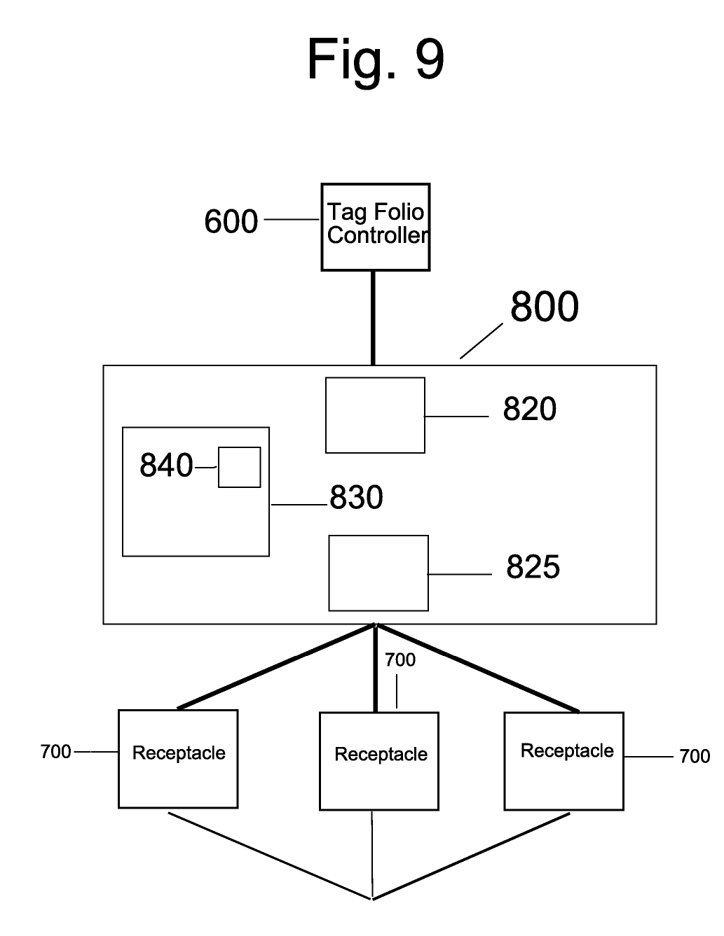

Presuming the customer used the TFC while making the purchase, the TFC will contain both the R_{id} as well as the secret and hashlocks for the tag. As shown in FIG. 9, an RFID receptacle 700 may comprise a connector 720 for connecting and transferring information to and from the TFC 600. Alternatively the customer could connect the TFC to a receptacle server 800, which may be connected to a plurality of RFID receptacles, as shown in FIG. 8.

Referring back to FIG. 9, an RFID receptacle 700 may be embodied as an RFID appliance like an RFID refrigerator, oven, or microwave; an RFID storage container like an RFID shelf, cabinet, or drawer; or an RFID enabled electronic device like a stereo, TV, DVD player, computer, cell phone, or PDA. The RFID receptacle 700 contains the same structure as the equivalent non-RFID receptacle (e.g., an RFID oven will comprise a door, a heating source, a rack, etc.) The RFID receptacle may also contain one or more specialized RFID components. The RFID receptacle 700 may contain an RFID reader 710 for reading RFID tags, a connector 720 for connecting the TFC 600 to the receptacle 700, a communicator 725 for communicating with the server 800, a processor 730, or a memory 740. The memory 740 may contain a database, tag information, or software or programs. Software written in the memory 740 of the receptacle 700, may cause receptacle to store information received from the TFC 600 or receptacle server 800, organize the information into a database, or retrieve the information from the database. The software may contain instructions to purge the memory after a certain time has passed or a certain number of uses of the data has occurred.

To use the RFID receptacle 700, the user may connect the TFC 600 to the RFID receptacle. Once connected (either wirelessly or by physical electrical connection), the TFC may upload all or some of the R_{id}'s and corresponding P_{id}'s to the memory of the receptacle 700. The TFC may also upload the secret and the hashlock for a given P_{id} to the receptacle 700. There are two ways a RFID receptacle 700 can make use of a tag's P_{id}. The first way involves having the receptacle store a mapping database linking the P_{id} and the R_{id}. If this database is established, the RFID receptacle can determine the corresponding R_{id}, when its RFID reader scans an RFID tag.

Alternatively, the user can pair the TFC and the electronic receptacle so that the electronic receptacle knows the Tag Folio's secret and hashlocks. When the Tag Folio changes the hashlocks of the tag during the POS transaction, the Tag Folio also changes the tag's secret. If the TFC uploads the secret to the receptacle 700, the receptacle can decrypt the tag by sending L₂( )′ to the tag through the receptacle's reader. For example, a very simple hashlock may be L₂( )=(35s*P_{id}), where “s” is the secret. Further, for this example, it is assumed that the receptacle is an RFID microwave, and the object is a TV dinner. When the TV dinner is brought near the microwave, the RFID reader 710 may automatically query the RFID tag on the TV dinner to respond with its P_{id}. In this example the P_{id}=10, and s=3. If the microwave is programmed with the tag's secret and the l₂( ) hashlock, the microwave can compute L₂( )=(35*s*10)=1050. The microwave then would send 1050 to the tag. Upon receipt of the L₂( )′ the tag will backscatter its R_{id}. Upon receipt of the R_{id}, the microwave can set its appropriate cooking settings.

In this simple example, it would be very easy to reverse compute the hashlock from the transmitted result. A potential eavesdropper would know the L₂( )′ was 1050 and the P_{id}( ) was 10. The eavesdropper might guess the hashlock is =105*P_{id}. This might spell a privacy disaster for the ordinary user of RFID tags, but with Tag Folio the TFC may use a different secret for each tag (or a different secret for a set number of tags). The secret for another tagged item (maybe some instant noodles) might be 45 and the P_{id} could be 20. The eavesdropper might try to send L₂( )′ to the tag on the instant noodles which would computed to be 2100 (105*20). However, the tag will not reveal its R_{id}, because the value of L₂( ) is really 45*35*20=31,500.

To summarize, the TFC 600 can upload the secret and hashlocks, or the tag's R_{id} to the receptacle 700. As one might imagine, connecting each RFID receptacle one at a time to the TFC 600 would be time consuming, but this obstacle can be overcome by the use of the receptacle server 800.

A receptacle server 800 as shown in FIG. 8, is a computer that is designed to be connected (wirelessly or otherwise) to at least one RFID receptacle. The server 800 may be composed of ordinary computer hardware such as a Dell® Poweredge® server or an Apple® MacBook®. The actual hardware requirements would depend on the amount of receptacles connected, how often they required information, and the amount of data that would be transferred. The server 800 may comprise: a connector 820 to interface with the TFC 600, a communicator 825 to communicate with the RFID receptacles 700, and a processor 830 to execute software or instructions written in the memory 840.

To use the receptacle server, a user may connect the TFC 600 to the connector 820. Once connected, the TFC 600 may upload all of its secrets, hashlocks, R_{id}'s, and P_{id}'s to the receptacle server or some combination thereof. Once the information has been uploaded, the user can scan an RFID tag with the RFID Reader 710 to capture the tag's P_{id}. If the receptacle does not know or cannot determine the R_{id} of the tag, it may query the server 800 for more information. Upon receipt of the query, the server 800 may upload all or some of the information it has in its memory. Some embodiments of the server 800, may restrict the transfer of information to a need-to-know basis only divulging specifically requested information for increased security.

III) Tag Seal

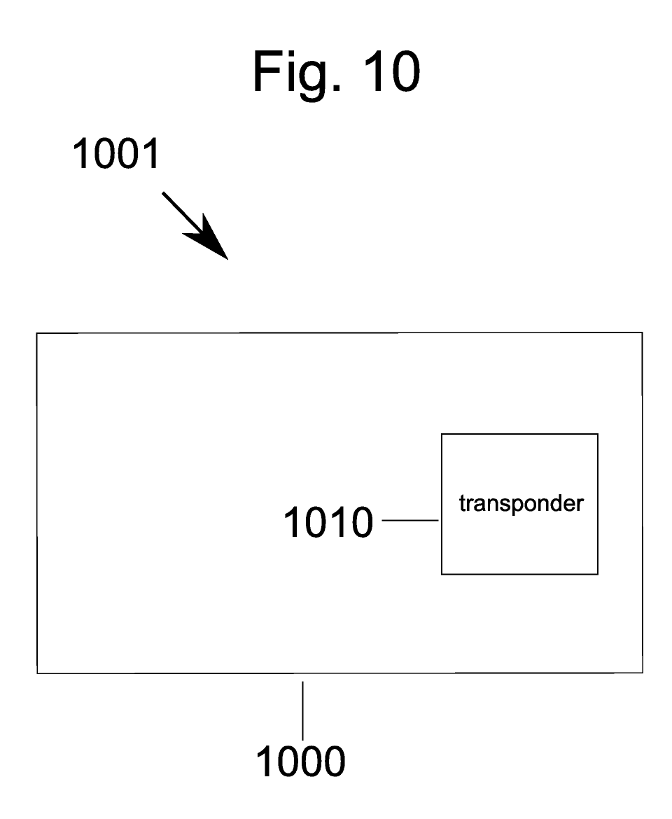

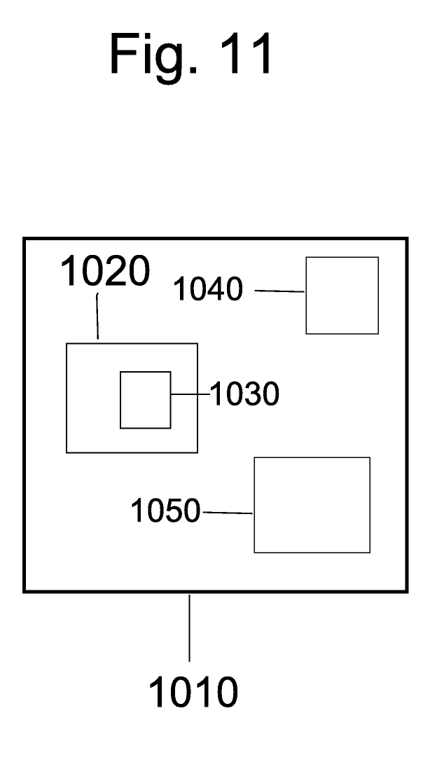

The development of the Tag Folio Controller also enables the construction of a secure electronic transaction system which will be referred to as Tag Seal 1001. An embodiment of the present invention would allow customers the convenience of an express pay system while minimizing many security risks associated with prior art RFID electronic transactions. Referring now to FIGS. 10 and 11, a housing, such as a card or fob 1000 with an integrated RFID transponder 1010 is provided. The transponder 1010 includes a processor 1020, memory 1030, receiver 1040, and a transmitter 1050. The housing may be made from any type of plastic, rubber, or wood material capable of housing a transponder. The housing 1000 may take the form of a credit card or debit card like a VISA® or MASTERCARD® cards. The advantage of using a credit card or debit card instead of an ordinary plastic housing 1000 is that the card would be backwards compatible with a magnetic strip reader. The memory 1030 may contain one or more identities as well as one or more account or credit card numbers for use in electronic transactions. In addition, one or more hashlocks and at least one secret, may be stored in the memory 1030. Software stored in the memory may provide instructions to cause the processor 1020 to enable or disable use of the transponder 1010 for electronic transactions. In some embodiments, it may be useful to have software in the memory of the transponder that automatically causes the processor to disable the transponder after a period of time, after a certain number of uses, or after the transponder leaves an electromagnetic field which may be generated by an RFID reader.

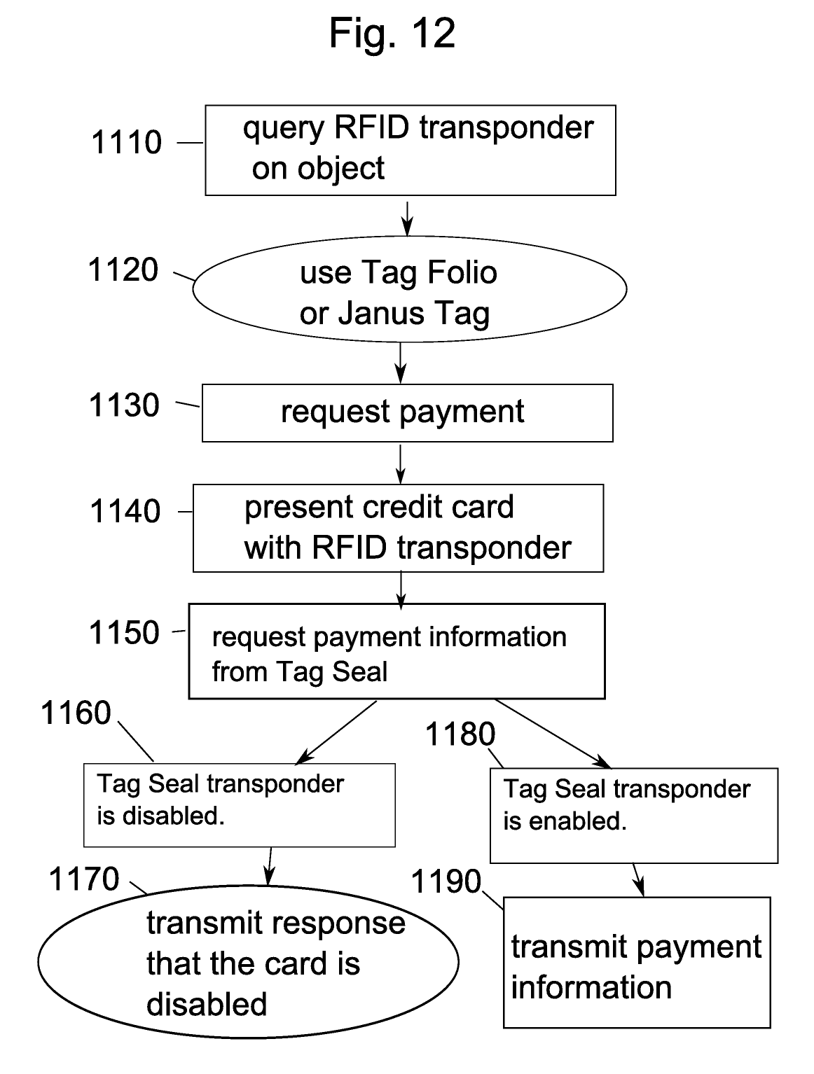

There are many uses for Tag Seal 1001 including inventorying goods and tracking personnel. Tag seal 1001 would also have utility in library systems or POS transactions. By way of example, a POS sale transaction will be described, but other techniques for using a Tag Seal card 1000 may be used. To use Tag seal 1001 for an electronic POS transaction, one may bring an RFID tagged object to a POS register so that the seller could query the object's transponder 100 with an RFID reader 200, step 1110 as shown in, FIG. 12. The seller may employ the use of a Janus Tag 300 and/or Tag Folio system 601 to provide the user with additional layers of security, step 1120. Either way, if the reader 200 can learn the real identity of the tag, the reader can send the identity to a cash register or computer. The register may calculate the total cost and prompt the purchaser to tender payment, step 1130. The purchaser presents the Tag Seal 1001 to the RFID reader, step 1140. The register requests payment via the transponder 1010 in housing 1000, step 1150. If the transponder 1010 is disabled (step 1160), the tag may not respond at all or send back a transmission indicating that electronic transactions are currently disabled, step 1170. If the transponder 1010 is enabled (step 1180), then the transponder 1010 may transmit the payment information to the reader, step 1190.

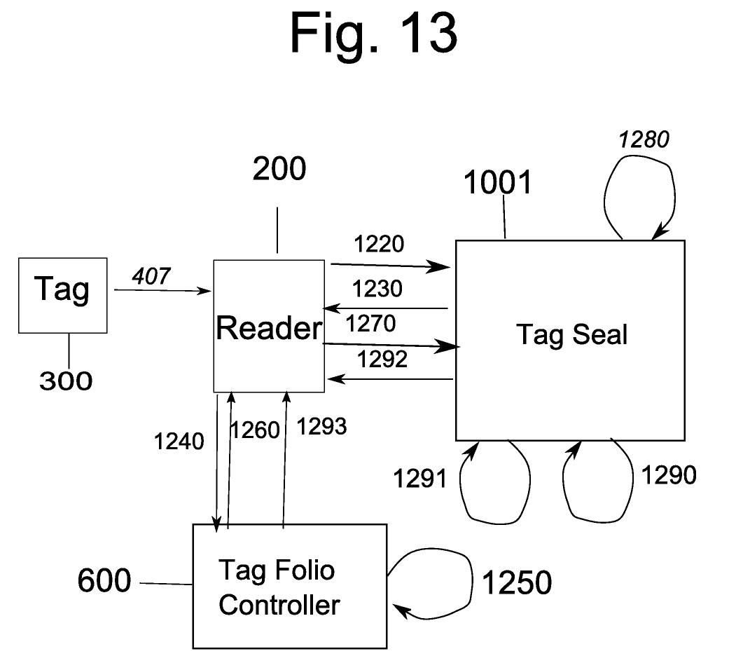

To convert Tag Seal 1001 from a disabled state to an enabled state, one may use a Tag Folio Controller 600, (see FIG. 13). The Tag Folio Controller could receive the real identity from the transponder 1010 through the seven step method described as steps 401-407 supra. The reader may query the transponder 1010 in the housing 1000, step 1220. The tag 1010 may respond with a public identity, and use a Tag Folio/Janus Tag system to shield the real identity from the reader 200. The transponder 1010 may also transmit to the reader a challenge, step 1230. A challenge is preferably a number, a character string or a combination thereof. The reader may receive the public identity and the challenge and then transmit them to the Tag Folio Controller 600, step 1240. The TFC 600 may lookup the hashlock(s) and the secret for this public identity as in step 1250, and compute the value of the hashlock. The Tag Folio Controller may transmit the value of the hashlock, Lₓ( )′ back to the transponder 1010 through the reader (steps 1260 and 1270). The transponder 1010 may process the value of the hashlock, Lₓ( )″ in its memory 1030, step 1280. The processor 1020 may then compare Lₓ( )′ with Lₓ( )″, step 1290. If the values match (or, in some embodiments, are within a certain threshold of matching) the processor will enable Tag Seal 1001 to be used for electronic transactions, step 1291. If the values do not match or are not within the threshold level, Tag Seal will remain disabled.

Once the Tag Seal 1001 is enabled, the transponder 1010 can send the payment information to the store's RFID reader, step 1292. Sending the information to the reader broadcasts the account numbers or credit card numbers of the transponder 1010, which is a significant security risk. To mitigate this risk in the past, credit card companies required an accompanying written signature on the credit card slip. This slows down the electronic transaction and increases cost. To alleviate this problem, the TFC can transmit an electronic signature to the reader, step 1293. Because the TFC can securely connect to the reader through SSL, digital certificate exchange, physical wires, etc, there is a greatly reduced risk of a third party being able to intercept this information. In some embodiments, the Tag Folio Controller may be programmed with a subroutine that causes the TFC to remain in a locked state requiring an identifying code such as a PIN, fingerprint, voiceprint, etc., before use. When the customer goes to a POS register to pay for the item, he or she enters the identifying code into the Tag Folio Controller which unlocks the device. Once the Tag Folio Controller is unlocked, it can proceed with enabling the credit card and transmitting the digital signature to the store's RFID reader.

Conducting an electronic transaction with Tag Seal avoids having to sign credit card slips and also alleviates the need to physically swipe a credit card. However, the seller ordinarily would still provide the buyer with a paper receipt. Again, paper receipts require printers and paper and can slow down the electronic transaction process. The next section, e-Receipts allows a transponder to store an electronic receipt in memory, alleviating the need to print a paper receipt.

IV) The e-Receipt

Printing paper receipts can be time consuming and expensive for merchants. Paper receipts are also often discarded in public places thereby creating privacy risks for customers. Additionally, customers may be required to keep these receipts to return certain merchandise.

An aspect of the present invention provides an electronic receipt or an e-Receipt. The e-Receipt system may comprise the Tag Folio Controller and an RFID reader. The TFC may be designed to contain additional storage space to accommodate storing electronic receipts sent by the reader. The TFC processor may restrict read and write access when the device is unlocked. The TFC processor may also require different passwords for read or write access.

The TFC may be designed to store electronic receipts automatically once a secure link is established between the TFC and the reader. In some embodiments no passwords or identification information would be required to write information to the Tag Folio Controller memory. However, to protect the privacy of the user of the Tag Folio Controller, the Tag Folio Controller may be programmed to restrict read access to the memory. Individual privacy settings relating to read and write access may be individually modified by the user of the Tag Folio Controller.

V) Tag Shield

Tag shield provides techniques for protecting attackers from issuing unauthorized commands against someone else's transponders. In particular, if an attacker is able to silence or change the hashlocks of a competitor's tags, the owner of the tags may lose substantial amounts of information. Also, Tag Shield provides ways to determine if an attacker is attempting to obtain information from someone else's transponders. In addition to these benefits, Tag Shield helps reduce the ability of an attacker to kill a number of the owner's tags. In addition, Tag Shield also provides systems and methods for reducing an owner's ability to accidentally cause too much damage to the information stored on his or her tags.

The expression “killing a tag” has several meanings, and various tag manufacturers implement a tag's kill command differently. Some of these techniques include: locking a tag so it will not backscatter information, locking a tag and erasing internal registers, erasing the internal registers and randomly changing the password, erasing the internal registers and setting the password to an invalid value, cause the tag to physically damage its circuitry and or memory, and changing the impedance of the tag's antenna or reducing the receiver sensitivity.

Tag Shield provides many techniques to prevent the executing of unauthorized commands by an owner's tags. These techniques include A) Reader Misdirection, B) Neighborhood Watch, C) Reprieve, D) Deadline Timer, E) Stay of Execution, F) Confirmed Command, and G) Puzzle Rampup.

A) Reader Misdirection

A Reader Misdirection system comprises an RFID reader containing a processor, memory, a transmitter, and a receiver. The reader is capable of generating an electromagnetic field for powering RFID transponders within a certain proximity of the reader. The reader may comprise software within its memory to cause the reader 1610 to send periodic queries to the transponders within the reader's electromagnetic field. In some embodiments the reader may be preprogrammed with a list of tags. The reader may compute or be programmed with a Tree Walking map to efficiently singulate all the tags in this list. The problem with using this scheme is that it allows an eavesdropper to learn a portion of all the tags' id numbers.

To overcome this problem, a number of imaginary RFID tags may be programmed into the reader's memory. A reader may attempt to singulate the real and imaginary tags. An eavesdropping individual would not be able to determine from the reader's singulation broadcasts which tags are real and which tags are imaginary. This can greatly increase the number of imaginary tags in the eavesdropper's pirated list of tags. In some instances this may destroy the value of eavesdropping altogether. For example, if a competitor wants to know how many boxes of NIKE® shoes its competitor purchased, finding out that the competitor purchased between 100-400 boxes of shoes may not be useful enough data. Combining this problem with not knowing which shoe ID numbers are real and which are not, the eavesdropper cannot be sure a particular model was even ordered at all.

This technique also reduces the eavesdropper's ability to execute commands on the owner's tags. If the number of imaginary tags is much greater than the number of real tags, the additional bandwidth needed to figure out which tags are real and which are not can slow down an attacker's ability to compromise an owner's tag inventory. Moreover, the owner can implement the Neighborhood Watch scheme to draw the owner's attention to an eavesdroppers actions or prevent the tags from reacting to the eavesdropper's actions.

B) Neighborhood Watch

The Neighborhood Watch refers to the activities of an owner's RFID equipment. The Neighborhood refers to an owner's tags, readers, servers, controllers, or other RF equipment. An attacker's or an eavesdropper's RF equipment is not part of the Neighborhood.

In a Neighborhood Watch scheme, the owner's tags and readers may monitor the activities of other tags in the Neighborhood. Thus when an attacker starts issuing unauthorized commands, the Neighborhood may take notice of the event and take appropriate steps, such as increasing Kill resistance or notifying the owner.

Identifying authorized events from questionable events can be a difficult problem though. One way to make this identification is to monitor the Neighborhood for transmission of commands to imaginary tags. Should third party reader attempt to send a silence command to an imaginary tag, the readers in the Neighborhood could be programmed to receive this command and take appropriate action.

If a message is sent encrypted, the readers may not be able to decrypt the transmission, because they do not know which tag was the intended recipient. To overcome this problem, one could design the software in the transponders to require the information to sent encrypted and unencrypted. For example, assume a friendly reader (one that belongs in the Neighborhood) has been instructed to kill Tag T_{c}. The friendly reader may obtain authorization as discussed in the Tag Folio and Tag Directive sections and send a kill command to the Tag T_{c}. The transmission that would be sent may appears as follows: t=Eₛ(c|command), where t is the transmission, E is an encryption function, s is the secret which is required to decrypt the function, c is the challenge, and the command is a command for the tag to execute. One problem with using this command by itself is that no other tags or readers can determine what message is being sent. To avoid this problem, the reader's and tag's software may be designed to require the addition of the command to the transmission, i.e., Eₛ(c|command)|command. This would allow other readers to know what command is being sent, and still require the reader to use the tag's secret. For additional security, the tag can have a software routine which checks the encrypted command with a decrypted command to make sure they are the same. If they are not the same, the tag may disregard the command or notify the neighborhood that an inconsistent transmission was received.

If the required transmission is something like t=Eₛ(c|KILL)|query, the tag might alert the neighborhood, but the neighborhood would not know which reader sent this transmission or when it was sent. So optionally, we can append this information as well to the transmission:
t=RₓEₛ(Rₓ|tᵢ|command)|tᵢ|command.

Where Rₓ is the serial number of the reader, and tᵢ is the time. If an inconsistent transmission is sent, the Neighborhood can query the reader Rₓ to determine whether that reader sent the transmission at the indicated time. If the reader did send the message, the Neighborhood can take that reader offline, require diagnostics to be run on the reader, increase command resistance of the tags (command resistance schemes will be discussed in the next sections), take no action, log the event, notify the owner, etc. If the reader did not send the message, the Neighborhood could increase command resistance of the tags, notify the owner of the event, log the event, etc. In either case, if the event is logged, the Neighborhood readers or tags can be programmed to check the time of the last inconsistent transmission and take appropriate steps depending on the frequency or timing of the inconsistent transmissions. Examples of appropriate steps may be to notify the owner, jam the EM field, issue a reprieve command, or raise a tag's difficulty sentinel value. Some of these steps will be explained in greater detail in the next few sections.

Although notifying the owner that a possible security threat has been detected sounds like an excellent solution, in practice it does not provide the owner much additional protection. Often the owner does not have the technical expertise to make changes to the Neighborhood, does not appreciate the importance of the threat, does not read the messages generated by the Neighborhood etc. Often, all an owner wants is an intelligent Neighborhood that can perceive security risks and take its own actions to decrease vulnerability. Systems and methods for increasing the Neighborhood security are provided in the next several sections.

C) Reprieve

One shortcoming of the Neighborhood Watch system is that it only allows the Neighborhood to take appropriate actions after tags have been affected. If a large number of attacking readers are used, the owner could potentially have a large number of tags compromised before the Neighborhood realizes what happened.

To overcome this shortcoming, tags and readers can be designed to use a timer. The reprieve command allows the readers in the Neighborhood to cancel a certain command issued to the tag. The reprieve command can be used in conjunction with the timer, as disclosed in the following system and method.

A tag receives a command to execute a kill command. The tag starts the timer. Once the timer times out, the tag will execute the command, but should the tag receive a reprieve command before the Deadline Timer runs out, the tag will not execute the command. This system and method provides additional protection to the Neighborhood, but it assumes the attacker cannot spoof the timer.

D) Deadline Timer

There are many ways to implement a timer on an RFID tag, but the lack of a constant power source makes creating a timer difficult. Should power to the tag by an EM wave be interrupted, the countdown could be stopped. Moreover, timers that rely on the reader to provide intermittent transmissions to control the countdown, can be compromised by an attacker who might be able to possibly speed up the count. To overcome such problems the Deadline Timer is proposed.

A Deadline Timer may comprise an ephemeral memory, static memory, and a capacitor. In most configurations a Deadline Timer will be integrated into an RFID tag, and possibly share some circuitry with the RFID tag, and may receive or provide commands to and from the processor of the RFID tag. When the processor of the RFID tag wants to initiate the timer of the tag, it enters a code, N, (perhaps a random number) into the ephemeral memory. The tag may also check the value of a static memory to see if a code is already present there. If no code is present in the static memory, the tag may copy N to the static memory. The tag then begins the countdown.

There are a number of techniques to conduct this countdown. For example, the tag could increment a sentinel value until the sentinel equals N, or the tag could copy N into a new variable N′ and decrement N′ until N′ equals zero (or some other predefined value). On its own, the static timer can be neutralized by cutting the power to the tag. Though the timer may resume when power is restored to the tag, an attacker could execute a bunch of Kill commands and then withdraw power from the tags. Once enough tags are set into a kill cycle, the attacker could jam the EM field, to prevent the tags from receiving the reprieve command.

To counter this vulnerability, the tags also have the ephemeral memory. Once power is cut to the tags, the capacitor of the tag starts to discharge. Once, the capacitor is sufficiently discharged, the code stored in memory is erased. When the tag is repowered, software in the tag may check to determine whether the value of the ephemeral memory is blank and the value in the static memory is not blank (or some other initial value). In some embodiments, a tag will automatically place a new number in the ephemeral memory when it is repowered. When a tag is repowered, the processor may determine that a previous countdown process was interrupted if it finds the static memory contains a different number from the ephemeral memory. In such cases, the tag may discard the command (such as a kill command). If the value in the static memory is blank or null, the processor decides that no countdown was taking place and resumes normal tag operations.

Use of Reader Misdirection and Neighborhood Watch help reduce the ability of an attacker to issue unauthorized commands to tags in the Neighborhood. Reprieve and Deadline Timer allow, inter alia, the neighborhood to protect tags from executing unauthorized commands. The following four systems and methods provide techniques to tighten the security for other tags in the Neighborhood once a potential threat is detected.

E) Stay of Execution

As mentioned previously, an attacker could use jamming to prevent the reprieve command from reaching a tag. This tactic would be easily detectable in an environment that has readers expecting this attack. While the readers could then take steps to prevent other tags from being compromised, a number of tags could be killed or controlled at once.

One way to handle this problem is to build into a tag's software, a set of instructions that requires RF silence for a moment (various times could be selected as determined by the needs of the owner) before a tag will execute a command. This system may not be as useful for lower security operations, but for higher security operations like killing a tag, this system may be very useful. The system and method would work in the following manner:

A tag receives a command (such as a kill command) from a reader. The tag then starts a timer circuit on the tag. Presuming the tag is in a neighborhood with various readers, the tag would likely receive a number of RF transmissions before the timer expires. If the tag does receive other RF transmissions during timer the countdown, the tag will discard the command. If the tag observes RF silence, the tag will proceed with executing the command.

An obvious drawback to the Stay of Execution, is it requires RF silence for a period of time. This drawback may be overcome through the use of a shielded cage. To kill a tag using a shielded cage, the cage is placed around the tag after the reader issues the command. The cage shields the tags from the other RF transmissions allowing the tag's timer to run out, and then execute the command. Using an EM cage is much more conspicuous and would likely draw the attention of the owner. Moreover, it's unlikely the attacker would know to use an EM cage to issue certain types of commands.

F) Confirmed Command

The Confirmed Command system and method utilizes a forced computation period to reduce an attacker's ability to issue unauthorized commands. In the system, the reader first requests a tag's ID. The tag replies with its ID, “I”. The reader looks up the command password, Kᵢ, in a database, perhaps on a server. The reader transmits to the tag, Kᵢ and the command to execute. The tag verifies the Kᵢ and then sends a challenge “c” to the Reader. The tag may also start a timer (could be the Deadline Timer). The Reader calculates t=H(c), where H is a mathematical function. During this time the Tag's timer is counting down. If the tag receives any response for the value of t before the timer reaches zero (or its equivalent), the tag will not execute the command. If any friendly readers in the Neighborhood realize this command is unauthorized before the timer reaches zero they can send the wrong value for t, which would cause the Tag not to execute the command.

The main drawback of this system is that it requires friendly readers to protect the tags in the system. Also the readers will need to have software so that their processors (or that of a server) can determine when a command is authorized and when it is not. The next section describes a technique to overcome this obstacle, by disclosing how to program tags to protect themselves without a protecting reader nearby.

G) Puzzle Rampup.

The Puzzle Rampup system effectively makes issuing commands to a few tags easy, while making issuing commands on successive tags more difficult. In Puzzle Rampup the tags can listen to each other. When a tag is given a command to execute, the tags tell or give notice to the other tags in the Neighborhood that such a command was issued. The tags may also give and receive notice from an authorized reader. When the command is issued, the other tags may increment a difficulty counter D. D is increased each time (or some multiple thereof) a tag in the Neighborhood is given a command. The tags may also decrement D as a function of time. Tags using the Puzzle Rampup technique may also have a number of puzzles saved in memory where the puzzles Z( ) increase in difficulty. A more difficult puzzle takes a reader more time to solve. For example a tag might ask the reader to determine what two prime numbers need to be multiplied together to get 37,979. This might take the reader quite some time to calculate, but it would not take the tag much time to calculate as it chose the prime numbers, when it gave the product to the reader.

For example, assume that the reader has a list of all the prime numbers from 2-N, where N is 271 in this example. The tag then reviews what its current difficulty level is, let's say D=8. The tag may then select the 8^{th} and 9^{th} numbers from the list and multiple them together, and then ask the reader to factor them. Tags can be equipped with a number of different puzzles which could require a reader to reverse solve hash functions, reverse solve logarithms, or reverse solve a fractional exponent.

Regardless of which puzzle is selected, the tag should be able to increment the difficulty of the puzzle depending on the value of D. Thus, it requires more time to kill or issue a command to a larger group of tags, because each time another command is issued, the puzzle gets harder to solve. The tags may also contain a software routine that requires the reader to answer a given puzzle within a certain time period. If the reader does not answer the puzzle correctly within that time period, the tag may disregard the command.

VI) Tag Directive

Another way to improve the security relating to RFID transactions is to provide techniques to ensure that the individual who is transmitting a command to a tag has the authorization to do so. A technique to provide this authorization is called Tag Directive, and can be used to provide another layer of protection against Mass Killings of tags. Tag Directive may also be used to verify that the reader or TFC is in electronic communication range of the transponder.

The Tag Directive system and method can be used with the Deadline Timer technology to allow the TFC to execute a command for only a small time interval. If the timer expires, the tag resets, and the challenge may be different. As will be explained in greater detail, if the challenge is different, the tag will not perform the command. Once the timer expires, a new request would need to be made. Additionally, in some configurations such as the one described below, neither the reader nor the TFC can directly store the command password. Rather they will forward and receive an encrypted version of the password that they cannot unlock.

A) The Tag Directive System

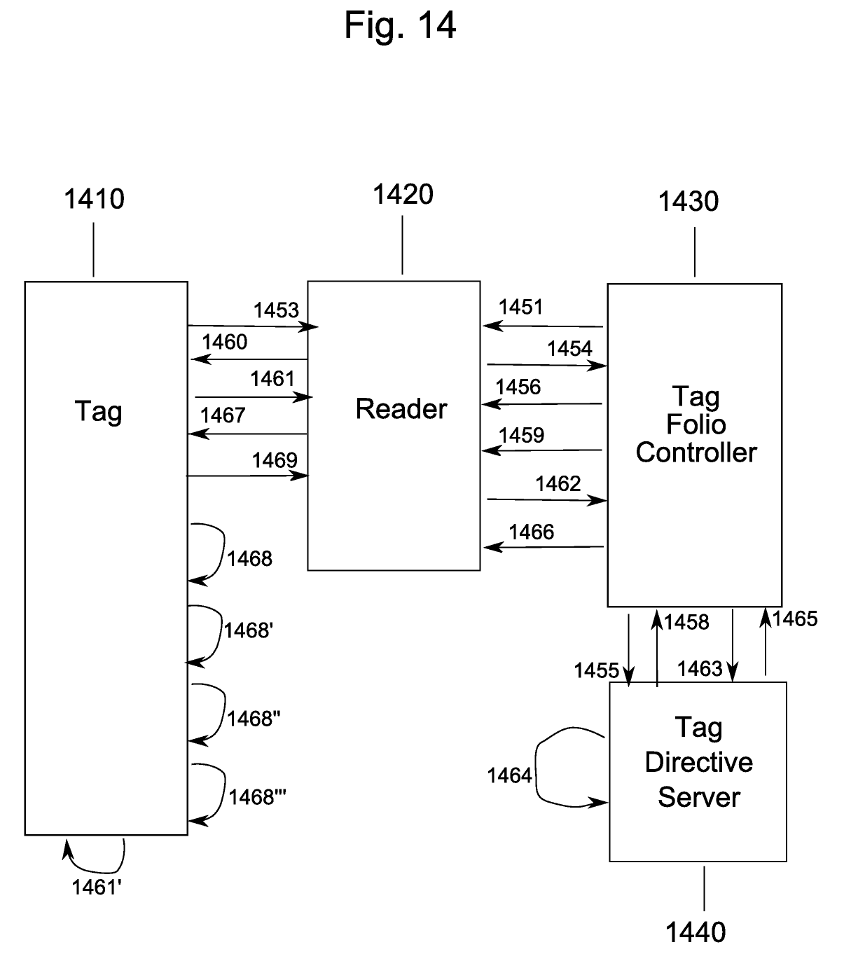

Referring now to FIG. 14, a Tag Directive system 1400 may comprise an RFID transponder or tag 1410, a reader 1420, a Tag Folio controller 1430, and a Tag Directive Server (TDS) 1440.

Transponder 1410 comprises a memory, processor, transmitter, and a receiver. The memory may comprise software to enable the transponder 1410 to perform at least one of the following functions: (i) reply to a request for an identity 1453; (ii) receive a challenge 1460; (iii) compute and transmit the value of the function Eₛ(c) where E is an encryption function, s is the tag's secret, and c is the challenge, 1461; (iv) start a Deadline Timer, 1461′; receive a credential, 1467; (v) determine whether the Deadline Timer has expired, 1468; (vi) decrypt the credential using the transponder's secret 1468′; (vii) verify the challenge in the credential matches the challenge presently stored in the tag's memory 1468″; (viii) process the command that was encrypted in the credential 1468′″; (ix) or transmit confirmation to the reader 1420 that the command has been executed 1469 (x). The credential may be generated by the server which has the tag's secret stored in memory such as Eₛ(c|command). The command could be a kill command, hash lock change command, silence command, reveal identity command, change identity command, or any other command the tag is capable of executing.

The reader 1420 contains all the necessary circuitry and software to enable the reader to communicate with the transponder 1410 and the Tag Folio Controller 1430. The reader 1420 needs to be able to relay transmissions from the transponder 1410 to the TFC 1430 and vice versa. In some embodiments, the TFC 1430 and the reader 1420 can be combined into one unit called a smart reader.

The TFC 1430 comprises a memory, processor, transmitter, and a receiver. The memory may comprise software to enable the TFC 1430 to perform at least one of the following functions: (i) transmitting a query to the reader to request the tag's ID (transmit an ACK command), 1451; (ii) receive the tag's backscattered ID from the reader, 1454; (iii) transmit an authorization request to the Tag Directive Server, 1455; (iv) transmit a request to perform a command on the transponder, 1456; (v) receive a challenge generated by the Tag Directive Server; (vi) forward the challenge to the reader, 1459; (vii) receive Eₛ(c) from the reader 1462; (viii) transmit Eₛ(c) to the Tag Directive Server, 1463; (ix) receive the credential Eₛ(c|command) from the server; (x) transmit the credential to the reader 1466; and receive acknowledgment from the reader that the transponder has executed the command.

The Tag Directive Server (TDS) comprises a memory, processor, transmitter, and a receiver. The memory of the TDS may comprise software to enable the TDS 1440 to perform at least one of the following functions: (i) receive from the TFC, an authorization request to interface with the transponder; (ii) receive a request for permission to issue a command to the transponder; (iii) run a query of TDS memory (or the memory of another server) to determine whether the TFC has authorization to perform commands on the transponder; (iv) generate and transmit a challenge to the TFC, 1458; (v) receive Eₛ(c) from the TFC; (vi) decrypt Eₛ(c) using the secret of the tag; and (vii) generate and transmit the credential to the TFC 1465. In most configurations, the transponder does not send the secret to the server. In these configurations, the server must have been previously programmed with the tag's secret. One way to program the server with this information is to upload the tag's secret from using the Tag Folio system as explained in section III above.

B) Tag Directive Operation

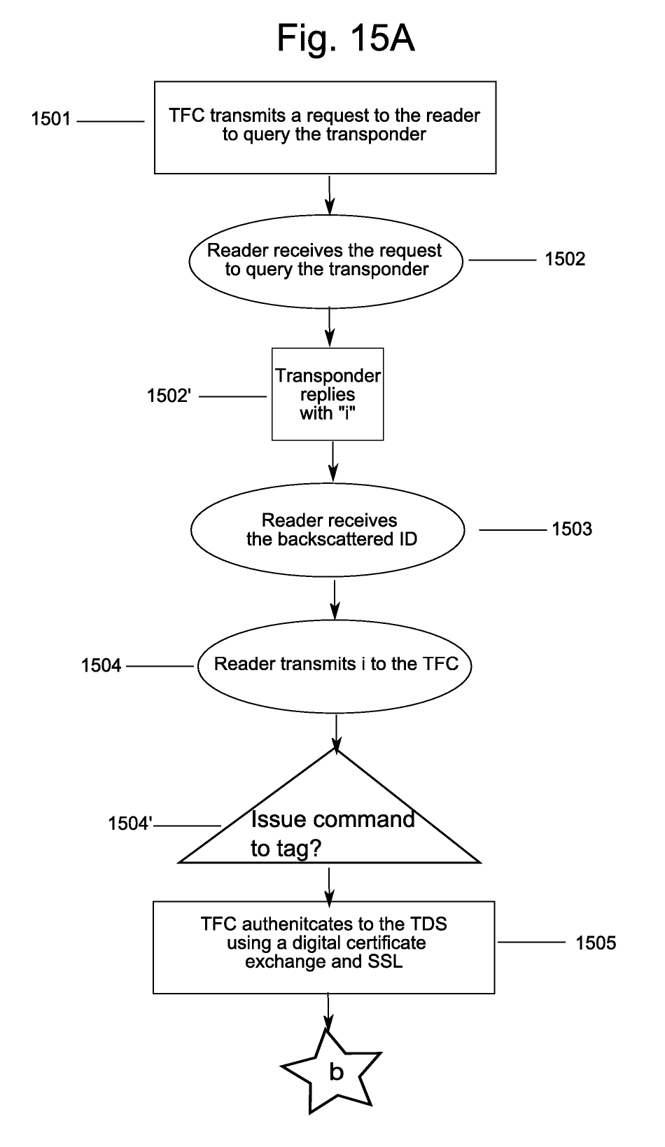

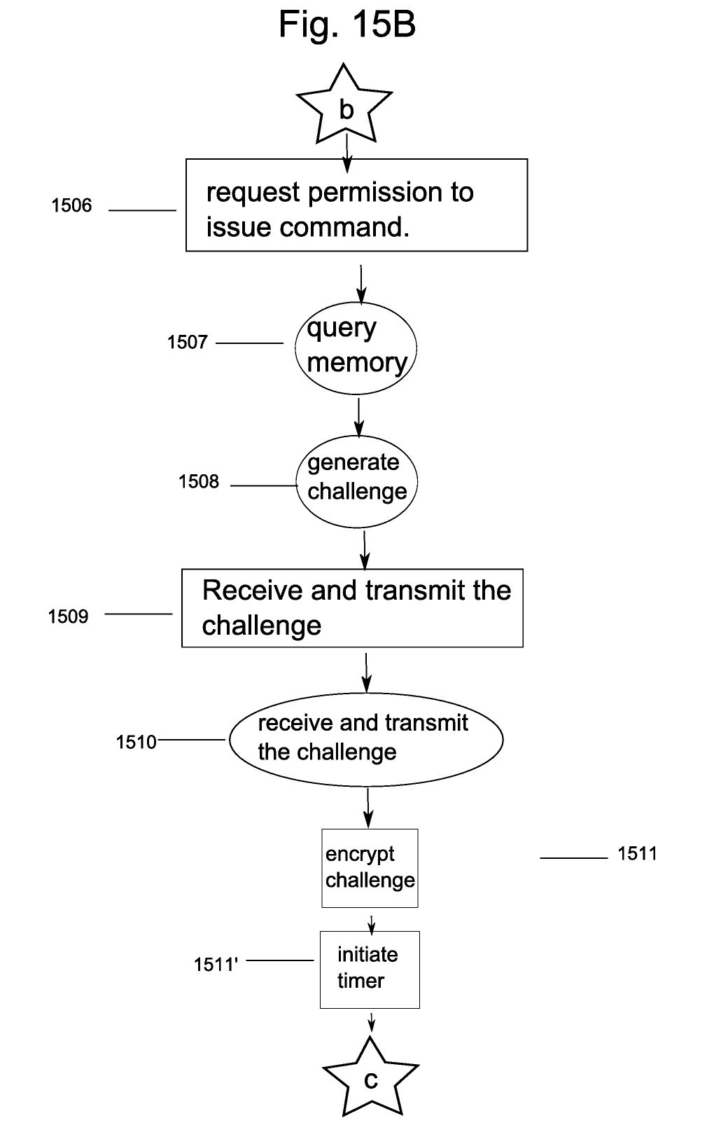

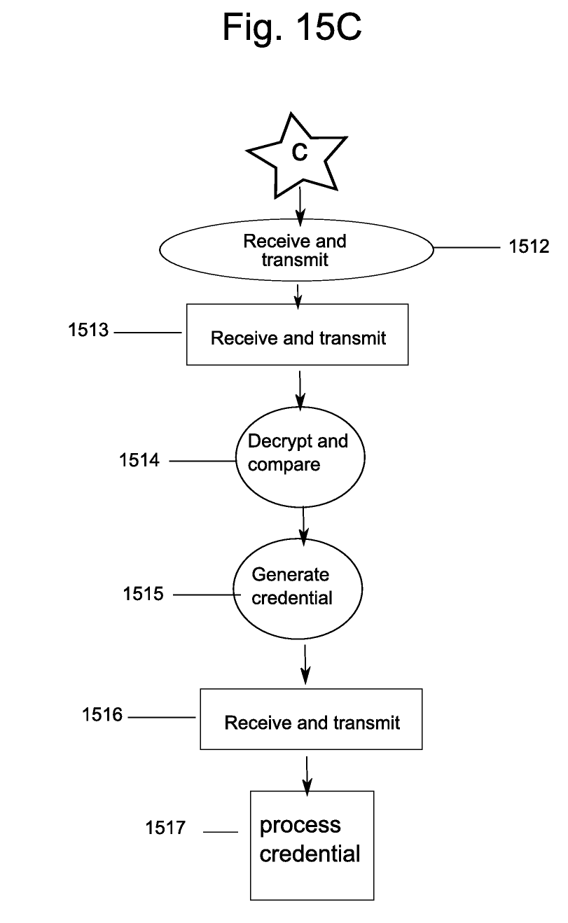

One may use the Tag Directive system by simply causing the processors in the transponder 1410, reader 1420, TFC 1430, and TDS 1440 to process the software code written in memory of each of four RFID devices. For pedagogical purposes, an exemplary method of using the Tag Directive system will now be disclosed, with reference to FIG. 15A. To initiate the method, a user enters a command into the TFC 1430 to cause the transmission of a request to the reader to query the transponder, 1501. The reader 1420 may receive the request, and query the transponder, 1502. The transponder 1410 may reply with its ID, i, 1502′. The reader may receive the backscattered ID, 1503. The reader may transmit i to the TFC, 1504. Once the TFC and user learn the identity of the tag, the user of the TFC (or the TFC through artificial intelligence) decides whether it wishes to issue a command to the tag. As an example, the user decides he or she wants to kill the tag. The user may cause the TFC to authenticate to the TDS using a protocol such as digital certificate exchange or SSL, 1505. Now with reference to FIG. 15B, the TFC may transmit its request to kill tag I, 1506. The TDS may query its memory or search in a database to determine whether this TFC has authorization to perform this command on the tag, 1507. Alternatively, the TDS could query another server for this information. The TDS may generate a challenge, such as a random number, transmit it to the Tag Folio Controller, and store the challenge in memory, 1508. The TFC may receive the challenge, and transmit it to the reader, 1509. The reader may receive the challenge and forward the challenge to the tag, 1510. The tag may generate Eₛ(c) and transmits it to the reader, 1511. Eₛ(c) being an encryption function where the tag encrypts the challenge using its secret. The tag may also start its Deadline timer 1511′. Now with reference to FIG. 15C, the reader receives Eₛ(c), and transmit it to the TFC, 1512. The TFC receives Eₛ(c), and transmits it to the TDS, 1513. The TDS decrypts Eₛ(c), and compares the received value of Eₛ(c) to the value it generates. 1514. If the challenge stored in the memory of the server matches (or are within a certain threshold) the encrypted challenge (which was just decrypted), the TDS creates a credential, Eₛ(c|Kill), and forwards the credential to the TFC, 1515. If the values do not match, the TDS could send a null credential back, not respond, or send a message to the TFC that the tag being queried does not have the correct secret in memory. The TDS could also notify that TFC that the tag may be a fake tag, since it does not have the correct secret. Assuming the values match, the TFC may receive the credential and forward it to the reader, 1516. The reader forwards the credential to the tag, 1517. The tag may then decrypt the credential using its key. Embedded or stored within the credential is the command “KILL.” The Tag may check the challenge to make sure it is the same as the one it used in step 1511, and that the Deadline Timer has not reached zero. If the challenge is the same and the Deadline Timer has not expired, the tag may execute the command. The tag may send an acknowledgement to the reader before executing the command. The reader may then receive and transmit the acknowledgement to the TFC.

VII) ID Misdirection

ID Misdirection relates to a technique for reducing the ability of individuals to eavesdrop on a company's or individual's ONS lookups. Though the following description references only ONS lookups of EPC numbers on the EPCIS server, a similar system can be made for looking up Tag ID numbers by querying a particular company's Tag ID server.

To construct an ID Misdirection system, a user makes at least one fake tag ID or EPC. In some configurations, there will be many fake EPCs, and the number of fake EPCs may be related or proportional to the number of real EPCs in the user's inventory. The user may then integrate the list of fake EPC lookups into the list of real ONS lookups. This may be done in a random sequence to make it more difficult for an eavesdropper to determine the fake EPCs from real EPCs difficult. When conducting the ONS lookups, the user may lookup the fake EPCs along with the real EPCs. The user may use a computer to perform the ONS lookups. The computer may be server, RFID reader, home computer, PDA, Laptop, TFC, or any other electronic device capable of interfacing with a Tag ID server.

After running the ONS lookups, the user may check the EPCIS server (the server that provides ONS lookup information) to determine whether anyone (an eavesdropper) has looked up the fake EPC. The EPCIS server may then send the IP address of the company or individual who had looked up the fake EPC. In some jurisdictions, the user may also be able to subpoena the IP address of the eavesdropper from the EPCIS server. Once the IP address is made known to the user, the user could contact the eavesdropper's internet service provider to learn the identity of the eavesdropper.

While this technique may be more or less effective depending on the location and sophistication of the eavesdropper, it will tell the user whether there is an eavesdropper capturing the user's ONS lookups. Knowing that one's ONS lookups are being captured may be sufficient information to prompt the user to: inform the owner of the EPCIS servers that the server is leaking information, improve the user's internet or intranet security, monitor the user's employees, or take other proactive steps to minimize exposure. If the user is implementing a TOR-ONS system to communicate with the EPCIS server, providing this information to the company regulating the TOR server may prompt the company to modify it's ONS proxies to remove those proxies that are leaking ONS information.

Another technique can be employed to create fake RFID tags. Fake RFID tags can be created that are not used for identifying real inventory. The user can monitor whether there are any ONS lookups being conducted on these fake tags either on the user's intranet or on the EPCIS server. In this system, the user's reader or server could contain a list of fake tags, so the user does not generate ONS lookups for these tags. The presence of ONS for these fake tags, would then be a strong indication there is an eavesdropper within a certain proximity of the tags.

The specific systems, methods, and software described are exemplarily only. Various other configurations of the invention can be constructed or used. No limitations or restrictions are implied or intended except as provided in the following claims.

It is claimed:

1. An RFID tag capable of storing two identities in its memory, the tag comprising a memory containing a public identity designed to be transmitted to an unauthenticated reader for identifying the tag, and a separate private identity designed to be transmitted only to an authenticated reader.

2. The RFID tag of claim 1, wherein the RFID tag comprises three hashlocks in memory.

3. The RFID tag of claim 1, wherein the public identity comprises a first identifying code and the private identity comprises a second identifying code.

4. The RFID tag of claim 3, wherein the first and second identifying codes comprise different values.

5. The RFID tag of claim 1, wherein the public identity is changeable and the private identity is not changeable.

6. The RFID tag of claim 1, wherein the tag is attached to an object, and the public identity of the tag corresponds to that object.

7. The RFID tag of claim 1, wherein the public identity or private identity contains sufficient information for reader to uniquely identify the tag.

8. A method for using a RFID tag, RFID reader, and a server comprising the steps of: providing an RFID tag having at least one hashlock in memory and at least two different identities; using an authenticated reader to query the tag's first identity; receiving the tag's first identity with the reader; sending the first identity of the tag to the server; looking up at least one hashlock associated with the first identity; computing the value of the hashlock; and transmitting the value of the hashlock to the reader.

9. The method of claim 8 comprising the step of transmitting the value of the hashlock to the tag.

10. The method of claim 9, comprising the step of receiving confirmation from the tag that it received the value of the hashlock and has performed a specified command.

11. The method of claim 9, comprising the step of sending additional information to the tag.

12. The method of claim 11, wherein the additional information is a new first identity for the tag to store in memory.

13. The method of claim 12, wherein the step of transmitting the value of the hashlock and the additional information to the tag causes the tag to change its first identity.

14. The method of claim 11, wherein the reader receives the additional information by capturing a first identity from a second RFID tag.

15. The method of claim 9, wherein after the step of transmitting the value of the hashlock to the tag, the tag backscatters a second identity different from the first identity.

16. The method of claim 11, wherein the steps of transmitting the value of the hashlock and sending the additional information to the tag cause the tag to change all of its hashlocks.

17. The method of claim 11, wherein the steps of transmitting the value of the hashlock and sending the additional information to the tag cause the tag to enter a silent mode.

18. The method of claim 11, wherein the steps of transmitting the value of the hashlock and sending the additional information to the tag causes the tag to kill itself.

19. The method of claim 8, wherein the server uses a secret and the first identity to compute the value of the hashlock.

20. The method of claim 8 comprising the steps of: receiving a second identity with the reader; sending the second identity to a controller separate from the reader and server; generating a new first identity; sending the new first identity to the reader; transmitting the new identity to the tag; and transmitting the value of the hashlock to the tag; whereby the tag is caused to change its first identity.

21. The method of claim 20 comprising the step of receiving a confirmation from the tag indicating that the tag successfully changed its first identity.

22. The method of claim 8 comprising the steps of receiving a second identity with the reader; sending the second identity to a controller separate from the reader and server; generating a new hashlock to replace the at least one hashlock currently present in the tag's memory; sending the new hashlock to the reader; transmitting the new hashlock to the tag; and transmitting the value of the at least one hashlock to the tag to cause the tag to change the at least one hashlock stored in memory to the new hashlock.

23. The method of claim 22, wherein the step of generating a new hashlock creates three new hashlocks, the step of transmitting the new hashlock sends all three new hashlocks to the tag, and the step of transmitting the value of the at least one hashlock to the tag causes the tag to change all three hashlocks stored in memory to the new hashlocks received in the previous step.

24-137. (canceled)
